(19) United States
(12) Patent Application Publication
(10) Pub. No.: US 2020/0215710 A1
(43) Pub. Date: Jul. 9, 2020

(54) VIBRATION CUTTING APPARATUS AND NON-TRANSITORY COMPUTER-READABLE RECORDING MEDIUM

(71) Applicants: NATIONAL UNIVERSITY CORPORATION NAGOYA UNIVERSITY, Nagoya-shi (JP); TAGA ELECTRIC CO., LTD., Tokyo (JP); FANUC CORPORATION, Yamanashi (JP)

(72) Inventors: Eiji SHAMOTO, Nagoya-shi Aichi (JP); Hongjin CHUNG, Nagoya-shi Aichi (JP); Takehiro HAYASAKA, Nagoya-shi Aichi (JP); Seiji HAMADA, Tokyo (JP)

(21) Appl. No.: 16/804,646

(22) Filed: Feb. 28, 2020

Related U.S. Application Data
(63) Continuation of application No. PCT/JP2018/031970, filed on Aug. 29, 2018.

(30) Foreign Application Priority Data
Aug. 29, 2017 (JP) 2017-164699

(51) Int. Cl. B26D 7/08; B23Q 17/12; B23Q 17/22; B23Q 15/013

(52) U.S. Cl. CPC B26D 7/086; B23Q 15/013; B23Q 17/22; B23Q 17/12

(57) ABSTRACT

A movement controller controls a feed mechanism to move a vibration device relative to a workpiece. A vibration controller controls vibration of piezoelectric elements of the vibration device. The vibration controller acquires a status value indicating a vibration control status and detects contact between a cutting tool and the workpiece or the like based on a change in the status value. The vibration controller acquires at least one among energy consumption required for the vibration and a resonance frequency as the status value. The vibration controller determines a relative positional relationship between the cutting tool and a rotation center of the workpiece based on coordinate values of at least two contact positions.

### CROSS REFERENCE TO RELATED APPLICATIONS

This application is based upon and claims the benefit of priority from Japanese Patent Application No. 2017-164699, filed on Aug. 29, 2017 and International Application No. PCT/JP2018/031970, filed on Aug. 29, 2018, the entire contents of which are incorporated herein by reference.

### BACKGROUND

### 1. Field of the Disclosure

The present disclosure relates to a vibration cutting apparatus that cuts a to-be-cut object (workpiece) while vibrating a tool.

### 2. Description of the Related Art

In recent years, it has been required that precise cutting work be performed on various to-be-cut objects. Patent document 1 discloses a cutting apparatus including a vibration device that causes a cutting edge of a cutting tool to elliptically vibrate relative to a to-be-cut object, and this cutting apparatus is capable of performing precision fine machining work on iron-based materials and brittle materials.

### CITATION LIST

### Patent Document

[patent document 1] JP2008-221427 A

### SUMMARY

When a cutting tool is newly attached to the cutting apparatus at the time of tool change, for example, it is required that a cutting edge position of the cutting tool be accurately measured to maintain high machining accuracy. It is thus conventionally required that a measuring instrument be attached to the cutting apparatus to measure the cutting edge position of the cutting tool, but it leads to an increase in cost, and a change in relative positional relationship between a coordinate origin of the cutting apparatus and a coordinate origin of the measuring instrument due to, for example, thermal deformation makes it difficult to accurately measure the cutting edge position.

In another method, a workpiece is first machined with a cutting tool, and a cutting edge position is corrected based on a result of measuring a shape of the machined workpiece. In this case as well, a measuring instrument is required for measuring the shape of the workpiece, and it cannot be denied that the cost is increased.

The present disclosure has been made in view of such circumstances, and it is therefore an object of the present disclosure to provide a technique for specifying a relative positional relationship between a tool cutting edge and a target object such as a workpiece without a measuring instrument, a technique required for specifying the relative positional relationship between the two without a measuring instrument, or a technique for specifying an error from a designed cutting environment without a measuring instrument.

In order to solve the above-described problems, a vibration cutting apparatus according to one aspect of the present disclosure includes a vibration device having a cutting tool attached thereto, the vibration device including an actuator structured to generate vibration, a movement controller structured to control a feed mechanism to move the vibration device relative to a target object, and a vibration controller structured to control the vibration of the actuator of the vibration device. The vibration controller acquires a status value indicating a vibration control status and detects contact between the cutting tool and the target object based on a change in the status value. The target object may be a workpiece, a component to which the workpiece is attached, or an object having a known shape.

Another aspect of the present disclosure is also a vibration cutting apparatus. This apparatus includes a vibration device having a cutting tool attached thereto, the vibration device including an actuator structured to generate vibration, and a controller structured to control a feed mechanism to move the vibration device relative to a workpiece or a component. The controller has a capability of acquiring a coordinate value when the cutting tool comes into contact with the workpiece or the component by controlling the feed mechanism to relatively move the vibration device. The controller determines a relative positional relationship between the cutting tool and a rotation center of the workpiece based on coordinate values when the cutting tool comes into contact with the turned workpiece or a reference surface whose relative positional relationship with the rotation center of the workpiece is known at least at two positions different from a rotation angle position of the cutting tool when the workpiece is turned.

Yet another aspect of the present disclosure is also a vibration cutting apparatus. This apparatus includes a vibration device having a cutting tool attached thereto, the vibration device including an actuator structured to generate vibration, and a controller structured to control a feed mechanism to move the vibration device relative to a workpiece or a component. The controller has a capability of acquiring a coordinate value when the cutting tool comes into contact with the workpiece or the component by controlling the feed mechanism to relatively move the vibration device. The controller determines a relative positional relationship between the cutting tool and at least one among an attachment surface of the workpiece, a feed motion direction of the workpiece, and a rotation center of the workpiece based on a coordinate value of a contact position on a reference surface whose relative positional relationship with at least one among the attachment surface of the workpiece, the feed motion direction of the workpiece, and the rotation center of the workpiece is known.

Yet another aspect of the present disclosure is also a vibration cutting apparatus. This apparatus includes a vibration device having a cutting tool attached thereto, the vibration device including an actuator structured to generate vibration, and a controller structured to control a feed mechanism to move the vibration device relative to a target object. The controller has a capability of acquiring a coordinate value when a cutting edge of the cutting tool comes into contact with a portion having a known shape of an object by controlling the feed mechanism to move the vibration device relative to the portion having the known shape of the object. The controller specifies information on the cutting edge of the cutting tool based on coordinate values when the cutting edge of the cutting tool comes into contact with the portion having the known shape of the object at least at three positions.

Yet another aspect of the present disclosure is also a vibration cutting apparatus. This apparatus includes a vibration device having a cutting tool attached thereto, the vibration device including an actuator structured to generate vibration, and a controller structured to control a feed mechanism to move the vibration device relative to a workpiece. The controller has a capability of acquiring a coordinate value when the cutting tool comes into contact with the workpiece by controlling the feed mechanism to relatively move the vibration device. The controller specifies, based on coordinate values when the vibration device is moved relative to the turned workpiece using a feed capability of the feed mechanism in a movement direction not used for the turning to bring the cutting tool into contact with the workpiece at least at two positions, at least one among an attachment error of the cutting tool, an error in shape of the cutting edge of the cutting tool, and a deviation in movement direction of the cutting tool relative to the workpiece.

Note that any combination of the above-described components, or an entity that results from replacing expressions of the present disclosure among a method, an apparatus, a system, a recording medium, computer program and the like is also valid as an aspect of the present disclosure.

According to the present disclosure, it is possible to provide the technique for specifying the relative positional relationship between the tool cutting edge and the target object, and the technique required for specifying the relative positional relationship between the two.

### BRIEF DESCRIPTION OF THE DRAWINGS

FIG. 1 is a diagram showing a schematic structure of a vibration cutting apparatus according to an embodiment.

FIG. 2 is a diagram showing a functional configuration of the vibration cutting apparatus.

FIG. 3A-FIG. 3D are diagrams showing states where an elliptically vibrating cutting tool cuts a to-be-cut object.

FIG. 4A and FIG. 4B are diagrams for describing a process of cutting the to-be-cut object.

FIG. 5 is a diagram schematically showing force acting between the elliptically vibrating cutting tool and the to-be-cut object.

FIG. 6A and FIG. 6B are diagrams for describing an outline of a cutting experiment on a workpiece.

FIG. 7 is a diagram showing a change over time in variation of power consumption in a bending vibration direction with no contact made.

FIG. 8 is a diagram showing a measurement result of a maximum cutting depth of a cutting mark and a lateral position of the workpiece.

FIG. 9 is a diagram showing a relationship between the variation of power consumption in the bending vibration direction and the maximum cutting depth of the cutting mark.

FIG. 10 is a diagram showing a regression line and a straight line representing a confidence interval of the regression line.

FIG. 11 is a diagram for describing a method for determining a relative positional relationship between the cutting tool and a rotation center of the to-be-cut object.

FIG. 12A and FIG. 12B are diagrams showing a method for deriving coordinates of a point A.

FIG. 13 is a diagram for describing a reference surface.

FIG. 14A and FIG. 14B are diagrams showing an example of the vibration cutting apparatus in which the vibration device is attached rotatable around a C axis.

FIG. 15 is a diagram showing a state where a cutting edge and a portion having a known shape of a reference block come into contact with each other.

FIG. 16 is a diagram showing a positional relationship between the cutting edge and the reference block.

FIG. 17 is a diagram schematically showing a state where the cutting tool is inclined when the cutting tool is brought into contact with an upper surface of the reference block.

FIG. 18 is a diagram showing changes in height of a contact position.

FIG. 19A and FIG. 19B are diagrams showing another example of the vibration cutting apparatus in which the vibration device is attached rotatable around the C axis.

FIG. 20 is a diagram showing a state where the cutting edge and the portion having the known shape of the reference block come into contact with each other.

FIG. 21 is a diagram showing a positional relationship between the cutting edge and the reference block.

FIG. 22 is a diagram showing a state where the portion having the known shape of the reference block is brought into contact with the cutting edge.

FIG. 23A and FIG. 23C are diagrams showing a state where the to-be-cut object is machined.

FIG. 24A and FIG. 24B are diagrams for describing a method for deriving an attachment error in tool center.

FIG. 25A and FIG. 25D are diagrams for describing a method for specifying an error in shape of a tool cutting edge.

FIG. 26A and FIG. 26B are diagrams is a diagram for describing a method for specifying parallelism between a rotation axis of the to-be-cut object and a tool linear motion axis.

FIG. 27 is a diagram for describing a method for specifying orthogonality between the rotation axis of the to-be-cut object and the tool linear motion axis.

FIG. 28A and FIG. 28B are diagrams for describing a method for estimating an attachment error in tool center.

FIG. 29 is a diagram for describing the method for estimating an attachment error in tool center.

FIG. 30A and FIG. 30B are diagrams for describing the method for estimating an attachment error in tool center.

FIG. 31A and FIG. 31B are diagrams for describing a method for deriving a B-axis rotation center.

FIG. 32 is a diagram conceptually showing a cutting feed direction and a pick feed direction during scanning-line machining work.

FIG. 33A and FIG. 33B are diagrams for describing the method for estimating an attachment error in tool center.

FIGS. 34A and 34B are diagrams for describing the method for estimating an attachment error in tool center.

FIG. 35 is a diagram showing a method for measuring an error in shape of the cutting edge.

FIG. 36 is a diagram showing a state of machining work with a straight cutting edge.

FIG. 37 is a diagram for describing an identification method.

FIG. 38 is a diagram for describing coordinate conversion.

FIG. 39A and FIG. 39B are diagrams showing a state where the cutting edge is brought into contact with a machining surface.

### DETAILED DESCRIPTION

A vibration cutting apparatus according to an embodiment has a capability of monitoring a status value indicating a vibration control status while conducting vibration control to maintain vibration of the vibration device substantially constant even when a change in cutting load or heat generation due to vibration occurs. The vibration control status value to be monitored corresponds to an amount of energy consumption required for vibration or a resonance frequency to be tracked, and the vibration cutting apparatus is capable of estimating a load applied to a vibration device by monitoring the vibration control status value. A technique is proposed in which the vibration cutting apparatus according to the embodiment uses the capability of monitoring the vibration control status value to detect contact between a tool cutting edge and a to-be-cut object (or a component to which the to-be-cut object is attached) and specify the contact position to measure an attachment position of a cutting tool.

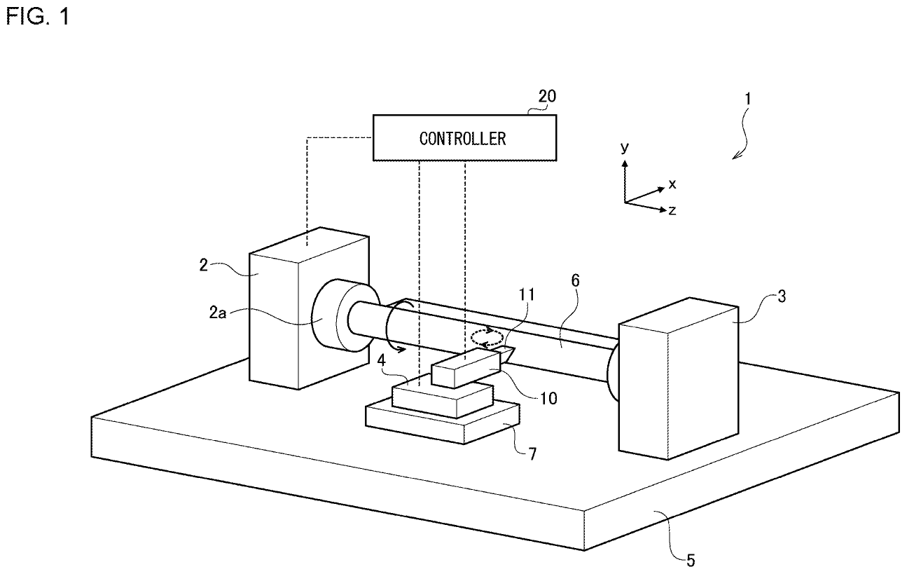

FIG. 1 shows a schematic structure of a vibration cutting apparatus 1 according to the embodiment. The vibration cutting apparatus 1 is a cutting apparatus that performs machining work of a turning type on a to-be-cut object 6 by causing a cutting edge of a cutting tool 11 to elliptically vibrate. The vibration cutting apparatus 1 according to the embodiment is a roll lathe that turns the to-be-cut object 6 having a cylindrical shape to form a rolling roll, but may be a cutting apparatus of any other type than a turning type. As will be described later, the present inventor uses a planing machine to conduct a verification experiment on a cutting edge position measurement method using the capability of monitoring the control status value, and the vibration cutting apparatus 1 according to the embodiment may be a cutting apparatus that causes the tool cutting edge to elliptically vibrate to perform vibration cutting work.

The vibration cutting apparatus 1 includes, on a bed 5, a headstock 2 and a tailstock 3 that support the to-be-cut object 6 rotatable, and a tool post 4 that supports a vibration device 10 to which the cutting tool 11 is attached. The vibration cutting apparatus 1 further includes a feed mechanism (not shown) that moves at least the tailstock 3 relative to the headstock 2, and a feed mechanism 7 that moves the tool post 4 in X-axis, Y-axis, and Z-axis directions. In FIG. 1, the X-axis direction is a horizontal direction and depth-of-cut direction orthogonal to an axis of the to-be-cut object 6, the Y-axis direction is a cutting direction that coincides with a vertical direction, and the Z-axis direction is a feed direction that is parallel to the axis of the to-be-cut object 6. In FIG. 1, positive and negative directions of each of the X, Y, and Z axes are directions when viewed from the cutting tool 11, but the positive and negative directions are relative directions between the cutting tool 11 and the to-be-cut object 6. Therefore, the positive and negative directions of each axis is not strictly defined herein, and when referring to the positive and negative directions, the directions shown in each drawing are followed. During cutting work, the to-be-cut object 6 is rotated by a spindle 2a provided on the headstock 2.

The vibration device 10 includes a vibrator to which the cutting tool 11 is attached and that causes the cutting edge of the cutting tool 11 to elliptically vibrate. The vibrator may include an actuator that generates vibration, and the actuator may be a piezoelectric element. According to the embodiment, the actuator generates vibration in the X-axis direction and the Y-axis direction to cause the cutting edge of the cutting tool 11 to vibrate in an elliptical path. A frequency of the vibration in the X-axis direction and the Y-axis direction is not particularly limited, but is preferably equal to or higher than 10 kHz, and more preferably equal to or higher than an ultrasonic range. The frequency in the ultrasonic range generally corresponds to a frequency higher than a human audible range, and may be, for example, a frequency equal to or higher than 16 kHz. The vibration cutting apparatus 1 uses an ultrasound frequency band to achieve machining with excellent silence. A controller 20 controls the vibration of the actuator of the vibration device 10, movement of the vibration device 10 by the feed mechanism 7, and rotation of the spindle 2a.

Note that, in FIG. 1, the feed mechanism 7 moves the cutting tool 11 relative to the to-be-cut object 6, but the feed mechanism 7 may move the to-be-cut object 6 relative to the cutting tool 11. That is, the feed mechanism 7 only needs to have a capability of moving the cutting tool 11 relative to an object such as the to-be-cut object 6, and, according to the embodiment, whether to move the cutting tool 11 or the object such as the to-be-cut object 6 may be determined based on the type of the vibration cutting apparatus 1.

The feed mechanism 7 may have not only a feed capability in translation directions along the X axis, the Y axis, and the Z axis but also a feed capability in rotation directions about an A axis, a B axis, and a C axis. The feed mechanism 7 according to the embodiment preferably has not only a feed capability in a movement direction that is required for cutting work but also a feed capability in a movement direction that is not used for cutting work. That is, the feed mechanism 7 is structured to have the feed capability in the movement direction that is not required (in other words, redundant) for cutting work in addition to the feed capability in the movement direction that is required for cutting work. The feed capability in the redundant direction may be used to move the cutting tool 11 relative to a pre-machined surface to be described later.

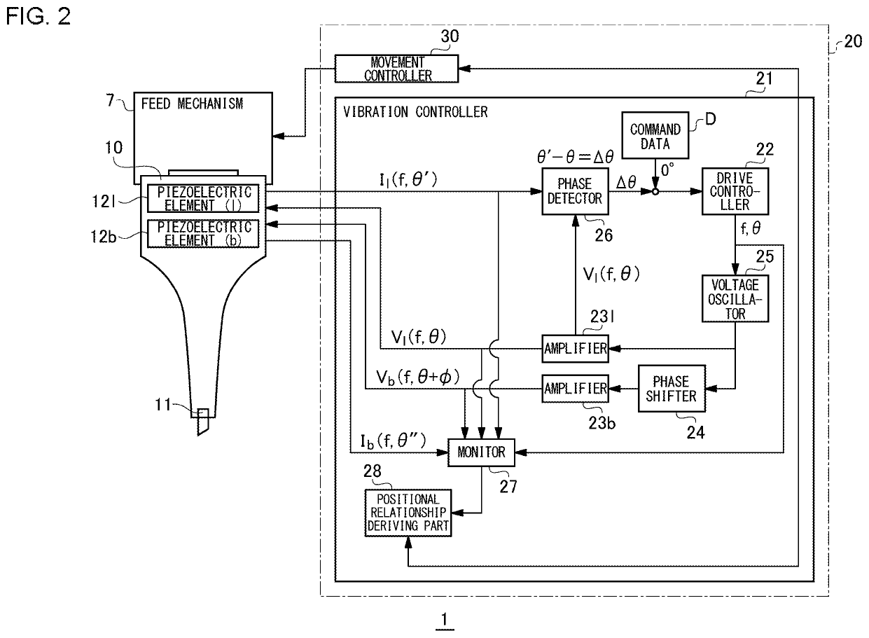

FIG. 2 shows a functional configuration of the vibration cutting apparatus 1. The vibration device 10 includes piezoelectric elements 121 and 12b that generate vibration and has the cutting tool 11 attached to a lower end of the vibration device 10. The piezoelectric element 121 vibrates the vibration device 10 in the X-axis direction (depth-of-cut direction). Hereinafter, the vibration in the X-axis direction may be referred to as “longitudinal vibration”. Herein, “1” that is an acronym for “longitudinal” is added to a reference numeral or symbol of a member related to the longitudinal vibration.

The piezoelectric element 12b causes the vibration device 10 to repeatedly bend in the Y-axis direction to vibrate the cutting tool 11 in the Y-axis direction (cutting direction). Hereinafter, the vibration in the Y-axis direction (lateral vibration) may be referred to as “bending vibration”. Herein, “b” that is an acronym for “bending” is added to a reference numeral or symbol of a member related to the bending vibration.

The controller 20 includes a movement controller 30 that controls the feed mechanism 7 that moves the vibration device 10 relative to the to-be-cut object 6, and a vibration controller 21 that controls the vibration of the piezoelectric elements 121, 12b of the vibration device 10. The movement controller 30 may have an origin of three-dimensional coordinates in the vibration cutting apparatus 1, and may control the movement of the vibration device 10 with coordinates of the cutting edge position of the cutting tool 11. Note that the controller 20 further includes a controller (not shown) that controls the rotation of the spindle 2a in the headstock 2. Hereinafter, a description will be given of a method in which the vibration controller 21 controls the vibration of the vibration device 10.

The vibration controller 21 includes a voltage oscillator 25 that generates a periodic voltage to be applied to the piezoelectric elements 121, 12b. The voltage oscillator 25 is controlled by a drive controller 22 to generate a voltage in accordance with a resonance frequency f of the longitudinal vibration and phase θ set by a command from the drive controller 22. The resonance frequency f is determined by a shape and weight distribution of the vibration device 10 and may vary depending on a cutting load, a temperature change of the vibration device 10, and the like.

The voltage generated by the voltage oscillator 25 is amplified by a first amplifier 231 and is applied to the piezoelectric element 121 as a voltage Vₗ (f, θ) in accordance with the resonance frequency f and the phase θ. The piezoelectric element 121 is driven by the application of the voltage Vₗ (f, θ) to generate the longitudinal vibration of the vibration device 10.

Further, the voltage generated by the voltage oscillator 25 is amplified by a second amplifier 23b via a phase shifter 24, and a voltage V_{b} (f, θ+φ) in accordance with the resonance frequency f and a phase θ+φ is applied to the piezoelectric element 12b. The piezoelectric element 12b is driven by the application of the voltage V_{b} (f, θ+φ) to generate the bending vibration of the vibration device 10. The amplifiers 231, 23b may be switching amplifiers, for example.

The phase shifter 24 shifts a phase of the voltage generated by the voltage oscillator 25 from 0 to θ+φ. When the phase shifter 24 is not provided, no phase difference appears between the voltages Vₗ and V_{b} to eliminate a phase difference between the longitudinal vibration and the bending vibration and cause the cutting tool 11 to linearly vibrate, but when the phase shifter 24 shifts the phase of the voltage only by φ, the cutting tool 11 moves along an elliptical vibration path formed by the longitudinal vibration and the bending vibration. Note that when the phase difference φ is variable, the vibration path can be made variable. Usually, since a phase lag of vibration relative to the voltage is slightly different between the longitudinal vibration and the bending vibration, the phase shifter 24 is also responsible for adjusting a difference between the phase lag of the longitudinal vibration and the phase lag of the bending vibration.

The vibration device 10 is formed to have a tapered shape that becomes thinner toward the cutting tool 11. Examples of the tapered shape include a conical horn shape, an exponential horn shape, and a step horn shape. The vibration device 10 is formed such that positions of nodes (portions where vibration becomes the smallest) in the longitudinal vibration and bending vibration coincide with each other at one or more, preferably two or more parts and is supported at the positions of the nodes that coincide with each other.

An order of the longitudinal vibration is determined based on the number of peaks (portions with a large amplitude) in the vibration device 10. For example, when there are three vertical vibration peaks at tool-side end, center, and opposite end, it is secondary longitudinal vibration. In the bending vibration, an order is determined in a similar manner. For example, when there are three bending vibration peaks, it is primary bending vibration. The vibration device 10 is designed to make resonance frequencies of the two vibrations approximately coincide with each other, but the resonance frequencies do not coincide with each other match due to a load or the like during cutting work. Therefore, the vibration controller 21 tracks the resonance frequency f of the longitudinal vibration that is relatively important for increasing machining accuracy and performs vibration control based on the resonance frequency f of the longitudinal vibration. Note that, in vibration control, the resonance frequency of the bending vibration may be used, or an average value of both the resonance frequencies may be tracked.

The vibration controller 21 includes a phase detector 26 connected to the piezoelectric element 121. The phase detector 26 detects a phase θ′ of a current Ii flowing through the piezoelectric element 121. The current Iₗ (f, θ′) in the piezoelectric element 121 is represented by the frequency f and the actual phase θ′ in the piezoelectric element 121. The phase detector 26 compares the phase θ′ with the phase θ of the voltage Vₗ (f, θ) in the amplifier 231 to obtain a difference Δθ (=θ′−θ). A frequency in the vicinity of the resonance frequency (electrically anti-resonance frequency) has a characteristic that makes the phase difference between the voltage Vₗ and the current Iₗ zero. According to the embodiment, feedback control for controlling the frequency f using this characteristic to make the phase difference Δθ close to zero is performed to track the resonance frequency.

Since the actual resonance frequency varies due to various factors (for example, a cutting load, heat generated in the vibration device 10 due to continuous vibration, or the like), the phase difference Δθ between the voltage phase θ and the current phase θ′ also varies. Therefore, the phase detector 26 compares the measured phase difference Δθ with a target phase difference (here, zero) indicated by a command data D and transmits the difference (error) to the drive controller 22. The drive controller 22 changes an oscillation frequency of the voltage oscillator 25 to make the phase difference Δθ 0° and tracks the resonance frequency. The vibration controller 21 according to the embodiment performs control to keep the vibration amplitude constant. In this amplitude control, power consumption (energy consumption) increases as the load increases. The vibration controller 21 has a phase lock loop (PLL) and tracks the resonance frequency f of the longitudinal vibration (the resonance frequency of the bending vibration is also in the vicinity thereof).

The controller 20 includes a monitor 27 that monitors a status value indicating a vibration control status. The monitor 27 receives a voltage corresponding to the resonance frequency f being tracked and further receives the voltage Vₗ (f, θ) and the current Iₗ (f, θ′). The monitor 27 calculates power Pₗ corresponding to energy consumed by the longitudinal vibration from a product (Vₗ*Iₗ). Note that since the voltage Vₗ and the current Ii varies periodically, an average value resulting from dividing the integral (over at least one period) of the product of the voltage Vₗ and the current Iₗ by an integration time (in discrete terms, an average value resulting from dividing an added value by the number of times of addition) corresponds to the power consumed by the longitudinal vibration.

The following (equation 1) is an equation for calculating the power (energy consumption) Pₗ from an instantaneous voltage Vₗ(t) and an instantaneous current Iₗ(t) at a time t. The power Pₗ is represented by (equation 1) in continuous time. Here, T denotes a period of vibration, that is, the inverse of the frequency f, m denotes an integer equal to or greater than 1, and t=0 is an integration start time.

$${P}_{l} = \frac{1}{mT} {\int }_{0}^{mT} {V}_{l} ( t ) {I}_{l} ( t ) dt \qquad ( EQUATION 1 )$$

In a case of digital measurement, when (equation 1) is discretized, the following (equation 2) is obtained. Here, n denotes the number of times of addition, Δt denotes a sampling interval, and n is preferably selected such that nΔt is exactly an integer period.

$${P}_{l} = \frac{1}{n Δ t} {\sum }_{k = 1}^{n} {V}_{l} ( k Δ t ) {I}_{l} ( k Δ t ) Δ t \qquad ( EQUATION 2 )$$

Similarly, the voltage V_{b} (f, θ) and current I_{b} (f, θ″) are input to the monitor 27. Here, θ″ denotes an actual phase in the piezoelectric element 12b. The monitor 27 calculates power P_{b} consumed by the bending vibration from a product (V_{b}*I_{b}) of an instantaneous voltage V_{b}(t) and an instantaneous current I_{b}(t) at the time t.

An equation for calculating the power P_{b} is represented by the following (equation 3) and (equation 4), similarly to (equation 1) and (equation 2). Note that the above-described power may be calculated by numerical operation using digital measurement results or may be calculated approximately by using an analog electric circuit that multiplies the instantaneous current and instantaneous voltage and averages the results of the multiplication. Since the above-described energy consumption (power consumption) is energy (power) consumed within a predetermined time, it may be regarded as an energy consumption rate (power consumption rate).

$$\begin{matrix}{P}_{b} = \frac{1}{mT} {\int }_{0}^{mT} {V}_{b} ( t ) {I}_{b} ( t ) dt & ( EQUATION 3 ) \\ {P}_{b} = \frac{1}{n Δ t} {\sum }_{k = 1}^{n} {V}_{b} ( k Δ t ) {I}_{b} ( k Δ t ) Δ t & ( EQUATION 4 )\end{matrix}$$

The positional relationship deriving part 28 acquires, in advance, the power Pₗ, P_{b} each corresponding to a status value indicating the control status of vibration, and the resonance frequency f from the monitor 27 when the cutting tool 11 is out of contact with the to-be-cut object 6 (when no load is applied). The positional relationship deriving part 28 may compares the power Pₗ, P_{b} and resonance frequency f acquired by the monitor 27 when no contact is made with the power Pₗ, P_{b} and resonance frequency f acquired when the cutting tool 11 is in contact with the to-be-cut object 6 (when a load is applied) to obtain a variation in each status value. Note that the vibration controller 21 according to the embodiment uses neither the current I_{b} nor the phase θ″ in PLL control of the voltage oscillator 25, but may use at least either the current I_{b} or the phase θ″.

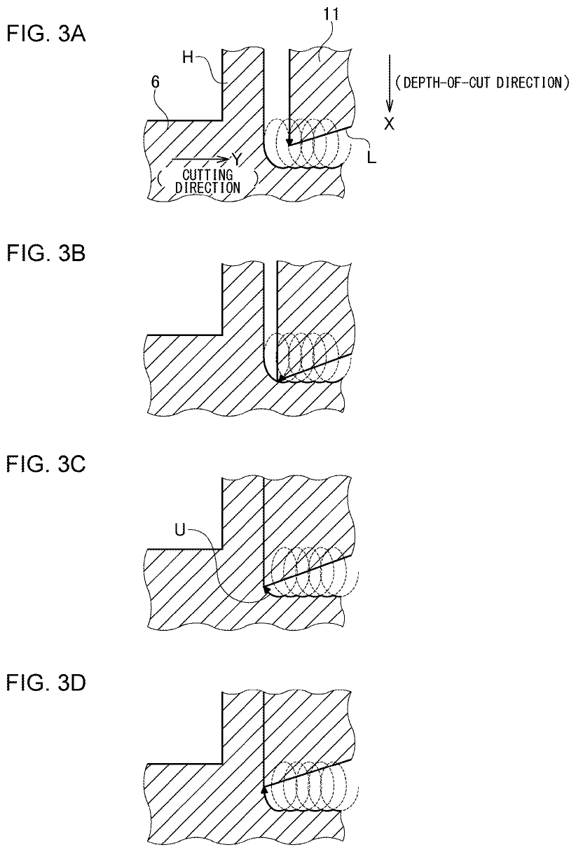

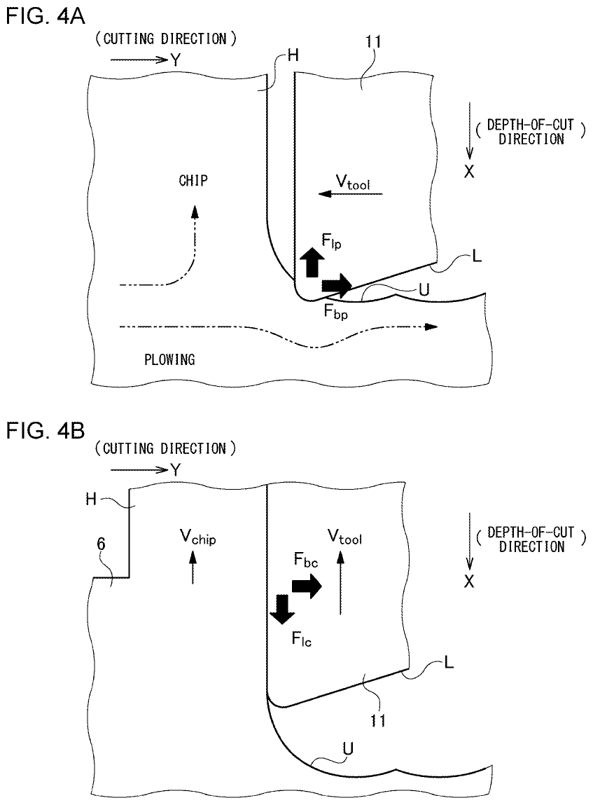

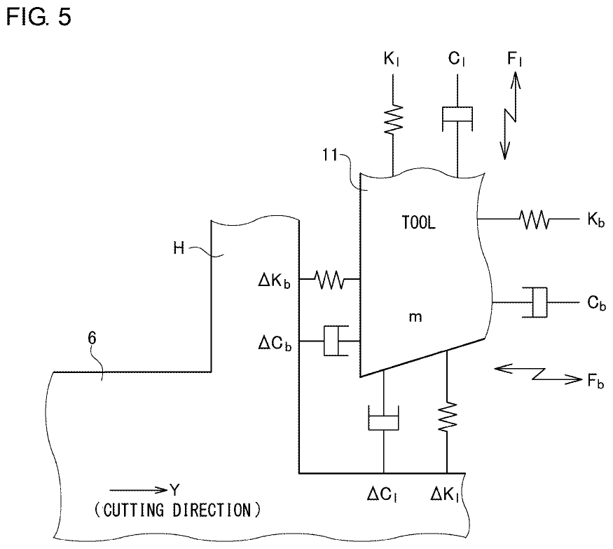

FIGS. 3A-3D and 4A-4B show states where the cutting tool 11 that is elliptically vibrated by the vibration device 10 cuts the to-be-cut object 6 (microscopic states over a very short time of about one vibration period), and FIG. 5 schematically shows force acting between the cutting tool 11 and the to-be-cut object 6. In FIGS. 4A-4B, Vₜₒₒₗ denotes a speed of the cutting tool 11, and V_{chip} denotes a speed of a chip H.

The cutting tool 11 (FIG. 3A) that has retreated toward a side in a direction identical to the cutting direction of the to-be-cut object 6 (Y-axis positive direction side) due to the bending vibration comes close to the to-be-cut object 6 due to the vertical vibration (X-axis positive direction, and then comes into contact with the to-be-cut object 6 (workpiece) and starts cutting (FIG. 3B). Microscopically, the cutting edge of the cutting tool 11 has a rounded portion at a tip and has a flank L that is gradually distanced from the to-be-cut object 6 relative to the tip (FIGS. 4A-4B).

When the cutting tool 11 comes relatively close to the to-be-cut object 6 in the X-axis positive direction that is a movement direction relatively close to the Y-axis negative direction (FIGS. 3A and 3B), and then pushes the rounded portion of the cutting edge to smooth the to-be-cut object 6 and causes the flank L to rub a surface just machined (machined surface U) (FIG. 4A). This machining process is called a burnishing process or a plowing process.

Next, the cutting tool 11 comes relatively close to the to-be-cut object 6 in the Y-axis negative direction that is a movement direction relatively close to the X-axis negative direction (FIGS. 3C and 3D). At this time, the cutting tool 11 rubs up the to-be-cut object 6 and pulls up the chip H as appropriate (FIG. 4B). This machining process is called a material removal process. Subsequently, when the cutting tool 11 is separated from the to-be-cut object 6, the material removal process for one cycle is terminated, and it returns to the state shown in FIG. 3A (however, a position advanced by one cycle).

In the burnishing process (FIG. 4A), the cutting tool 11 pushes the to-be-cut object 6 in the depth-of-cut direction (X-axis positive direction) and receives, from the to-be-cut object 6, reaction force Fₗₚ pushing back in the depth-of-cut direction (X-axis negative direction). The force Fₗₚ acts to push the longitudinal vibration back around a bottom dead center in the longitudinal vibration. Thus, the force Fₗₚ acts as an additional spring ΔKₗ against the longitudinal vibration.

The cutting tool 11 receives force F_{bp} in the cutting direction (Y-axis positive direction) from the to-be-cut object 6 when rubbing the to-be-cut object 6. The force F_{bp} acts to impede the bending vibration around a neutral point where the velocity is the fastest in the bending vibration. Thus, the force F_{bp} acts as additional damping (damper) ΔC_{b} against the bending vibration.

In the material removal process (FIG. 4B), the cutting tool 11 receives reaction force F_{lc} that pulls up the chip H of the to-be-cut object 6 and lowers the chip H in the depth-of-cut direction (X-axis positive direction). The force F_{lc} acts to impede the longitudinal vibration around a neutral point where the velocity is the fastest in the longitudinal vibration. Thus, the force F_{lc} acts as additional damping (damper) ΔCₗ against the longitudinal vibration.

Further, the cutting tool 11 relatively pushes the chip H in the cutting direction (Y-axis negative direction) and receives force F_{b}c (Y-axis positive direction) from the chip H. The force F_{b}c acts to push the bending vibration back around a left dead center in the bending vibration. Thus, the force F_{b}c acts as an additional spring ΔK_{b} against the bending vibration.

Due to the presence of the springs ΔKₗ, ΔK_{b} and damping ΔC_{b}, ΔCₗ in the machining process, the status value indicating the vibration control status of the vibration cutting apparatus 1, specifically, the values of the resonance frequency f and the power Pₗ, P_{b} vary during machining. Note that the actual vibration can vary depending on machining conditions and vibration conditions, but taking into account the springs ΔKₗ, ΔK_{b} and damping ΔC_{b}, ΔCₗ allows a tendency of the variation in the status value to be grasped.

For example, regarding the resonance frequency f of the longitudinal vibration, in the burnishing process, the greater the force Fₗₚ in the depth-of-cut direction, the stronger an elastic action of the spring ΔKₗ, and thus the higher the resonance frequency f becomes. Further, in the material removal process, the longer the force F_{lc} that pulls up the chip H continues even after the left dead center, the higher the resonance frequency f becomes. On the other hand, the longer the force F_{lc} that pulls up the chip H continues before the left dead center, the weaker restoring force (spring force) against the cutting tool 11 that tries to return to the neutral point in the vertical direction, and thus the lower the resonance frequency f becomes.

Further, regarding the power Pₗ, the presence of the damping ΔCₗ increases energy required for the longitudinal vibration compared to a case where the damping ΔCₗ is absent. Since the energy required for the longitudinal vibration is produced by the power Pₗ, an increase in the power Pₗ correlates with an increase in damping ΔCₗ. The increase in damping ΔCₗ means an increase in force F_{lc} in the material removal process, and it is therefore understood that, when the increase in power Pₗ is confirmed by the monitor 27, the force by which the cutting tool 11 pulls up the chip H increases.

Similarly, regarding the power P_{b}, the presence of the damping ΔC_{b} increases energy required for the bending vibration compared to a case where the damping ΔC_{b} is absent. Since the energy required for the bending vibration is generated by the power P_{b}, an increase in the power P_{b} correlates with an increase in damping ΔC_{b}. The increase in damping ΔC_{b} means an increase in force F_{bp} in the burnishing process, and it is therefore understood that, when the increase in power P_{b} is confirmed by the monitor 27, the force in the Y-axis direction received by the cutting tool 11 from the to-be-cut object 6 increases.

As described above, the monitor 27 according to the embodiment has a capability of monitoring the status value indicating the control status of vibration during cutting of the to-be-cut object 6. For example, as the cutting tool 11 wears, the force F_{bp} in the burnishing process tends to increase. Therefore, the monitor 27 can monitor the power P_{b} during machining work and detect that the wear of the cutting tool 11 has progressed when the increase in power P_{b} exceeds a predetermined value.

The monitoring capability of the monitor 27 described above is for monitoring the status value indicating the control status of vibration during machining, but the vibration cutting apparatus 1 according to the embodiment uses this monitoring capability when no load is applied, specifically when the attachment position of the cutting tool 11 is measured.

When the cutting tool 11 is newly attached to the vibration device 10 at the time of tool change, for example, it is required that, in order to allow the movement controller 30 to achieve high movement accuracy (machining accuracy), a coordinate value of the cutting edge position be accurately specified. In particular, of the power Pₗ, P_{b}, and the resonance frequency f corresponding to status values each indicating the vibration control status, the power consumption P_{b} required by the bending vibration responds to an increase in force in the Y-axis direction (cutting direction) and thus increases in response to contact between the cutting tool 11 and the to-be-cut object 6 with high sensitivity. The following example shows that contact detection is performed using a change (rise) in power consumption P_{b}, but the contact detection can be also performed using a different status value such as a change in resonance frequency f.

The present inventor conducted the verification experiment of the cutting edge position measurement method using the capability of monitoring the control status value. In this experiment, the vibration device 10 was installed on a planing machine, and the monitor 27 acquired the vibration control status value when the workpiece in feed motion was planed. Note that the purpose of this experiment is to detect the contact between the tool cutting edge and the workpiece to specify the contact position, and a consideration is further given to an error in the contact position under experimental conditions.

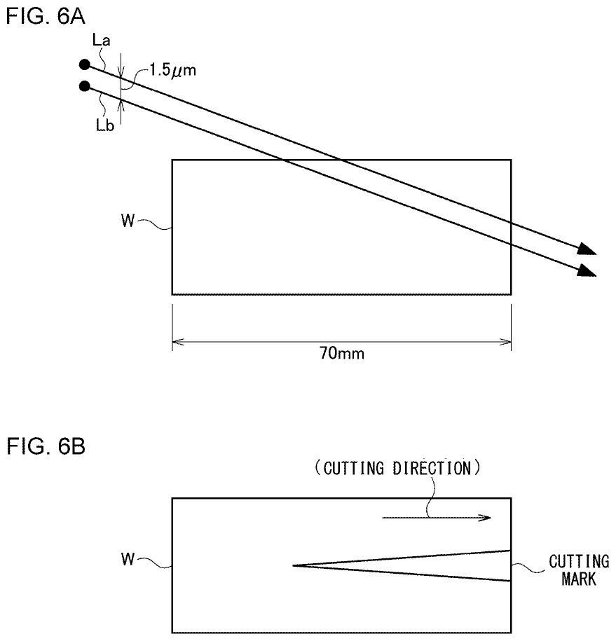

FIGS. 6A-6B are diagrams for describing an outline of a cutting experiment on a workpiece W. FIG. 6A shows that the workpiece W is cut obliquely from above, and FIG. 6B shows a state of a cutting mark observed on an upper surface of the workpiece W. The cutting mark has a shape that becomes gradually deeper and wider in the cutting direction.

This experiment was conducted under the following conditions:

Cutting tool: monocrystalline diamond (having a nose radius of 0.8 mm),

Workpiece W: Hardened steel 53HRC, and

Vibration condition: 17 kHz, 10 μm (p-p).

The vibration controller 21 caused the vibration device 10 to elliptically vibrate, the movement controller 30 moved the vibration device 10 in the depth-of-cut direction so as to gradually increase a cutting depth, and the monitor 27 measured the power consumption P_{b} required for the bending vibration. In the experiment, the workpiece W was cut along a line La and then cut along a line Lb where the tool cutting edge lowered by 1.5 μm from the line La, and the monitor 27 recorded the control status value at this time. Note that, in this experiment, from the viewpoint of protection of the cutting tool 11, cutting is performed by feeding the workpiece W in the cutting direction, but the contact detection can be performed without feeding the workpiece W.

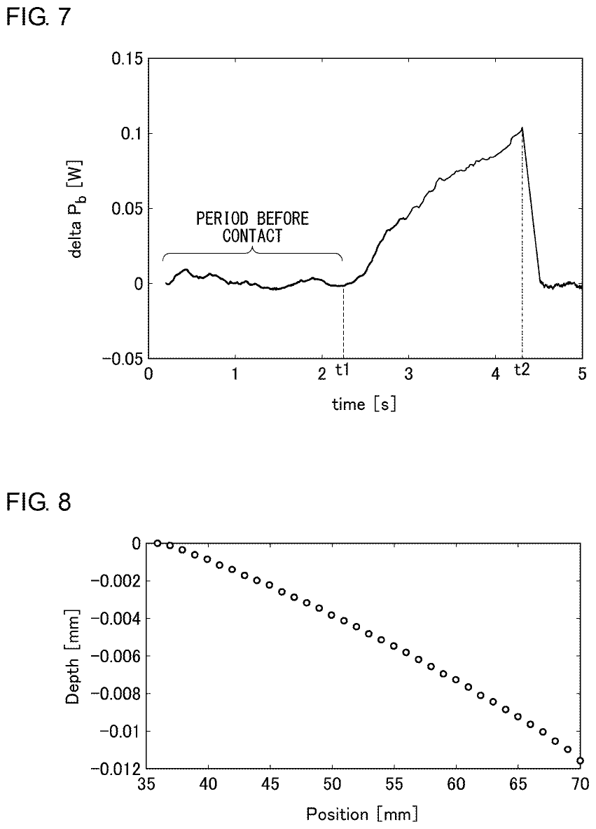

FIG. 7 shows changes over time in power consumption P_{b} in a bending vibration direction. Note that the vertical axis represents ΔP_{b} resulting from subtracting power when no load is applied from measured power consumption. FIG. 7 shows a measurement result in which ΔP_{b} increases from time a t1, and the increase in ΔP_{b} ends at a time t2. This means that the tool cutting edge comes into contact with the workpiece W and starts cutting at around the time t1, and, at around the time t2, cutting to a right end of the workpiece W ends, and the tool cutting edge is released from the load. The positional relationship deriving part 28 makes a change in power consumption at around the time t1 approximate to a straight line (curve) and obtains a position (t1′) where the approximate regression line (curve) crosses zero. When the positional relationship deriving part 28 passes the time t1′ thus obtained to the movement controller 30, the movement controller 30 returns control position coordinates of the vibration device 10 at the time t1′ to the positional relationship deriving part 28. The control position coordinates indicate the contact position between the cutting tool 11 and the workpiece W, allowing the positional relationship deriving part 28 to specify the contact position.

Note that noise is superimposed on a detection value of ΔP_{b}. When, in order to obtain position detection accuracy in this experiment, a standard deviation G of noise of the power consumption P_{b} in a period considered to be before contact was calculated, the following experimental values were obtained:

Average value M: −0.00096872 [W],

Standard deviation σ: 0.0033, and

Confidence interval of 95%: ±2G=±0.0066.

FIG. 8 shows a measurement result of the maximum cutting depth of the cutting mark and the lateral position of the workpiece W. In this experiment, the measurement result shown in FIG. 8 is obtained by cutting the workpiece W obliquely from above.

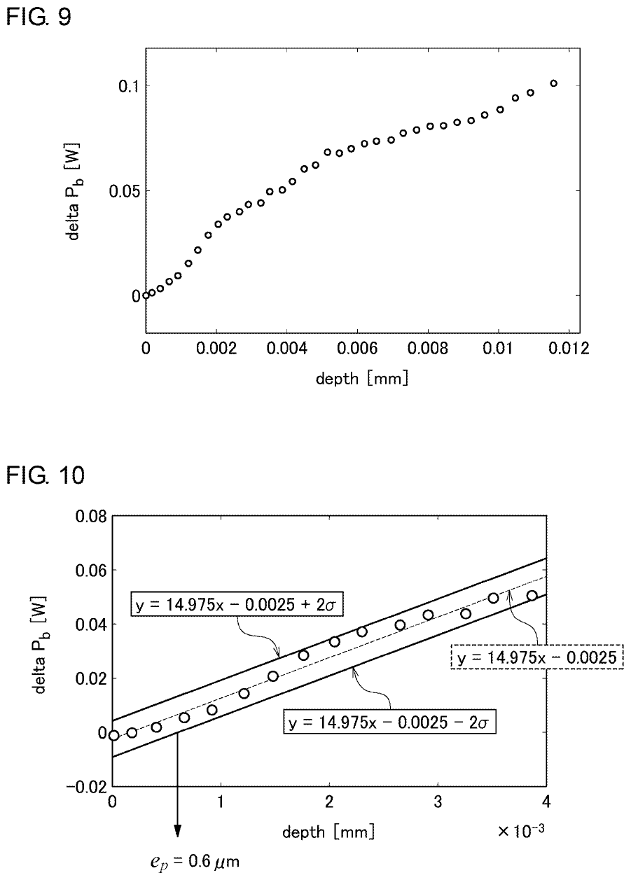

FIG. 9 shows a relationship between a change in power consumption P_{b} in the bending vibration direction and the maximum cutting depth of the cutting mark. The larger the cutting depth, the larger the cutting width and the larger the cutting load, satisfying a relationship in which ΔP_{b} increases in accordance with the cutting depth. In this experiment, changes in power consumption at the time of contact were made approximate to a straight line (curve) based on the relationship shown in FIG. 9, a position where the approximate regression line (curve) that crosses zero was obtained, and the detection accuracy of the contact position was calculated.

FIG. 10 shows a regression line derived using sampling points in the vicinity of the zero point and a straight line representing a confidence interval of the regression line. Here, the regression line is obtained using the least squares method as follows:

y=14.975x−0.0025. Note that, in this example, the regression line is obtained, but a regression curve that is a multi-order function may be obtained. In this experiment, a detection error eₚ of the contact position was derived to be 0.6 μm as shown in FIG. 10. In order to reduce the position detection error, it is only necessary to increase a sampling rate to increase the number of samplings, and take a moving average.

As described above, in the experiment, the monitor 27 acquires and records the changes (increases) in power consumption P_{b} in the bending vibration direction, and the positional relationship deriving part 28 specifies the tool position at a moment when a change occurs (time t′), that is, when the tool cutting edge comes into contact with the workpiece W. There are various specifying methods, but as an example, the least square method can be used to specify the tool position with high accuracy. In order to increase the accuracy when specifying the tool position, it is only necessary to increase a sampling rate to increase the number of samplings, and increase the number of moving average points to increase the accuracy.

As described above, the vibration cutting apparatus 1 acquires the status value indicating the control status of vibration when no load is applied, and detects the contact between the cutting tool and the to-be-cut object (workpiece) based on the change in the status value to determine the contact position. In the above-described experiment, the power consumption required for the bending vibration, specifically the power consumption required for the bending vibration, was used to detect the contact between the cutting tool and the to-be-cut object, but the contact between the cutting tool and the to-be-cut object can also be detected by analyzing a fluctuation value of the resonance frequency f of the longitudinal vibration.

As described above, the controller 20 has a capability of controlling the feed mechanism 7 to relatively move the vibration device 10 and acquiring the coordinate value when the cutting tool 11 comes into contact with a contact target object such as the to-be-cut object 6. A description will be given below of a method for determining a relative positional relationship between the cutting tool 11 and the target object in the vibration cutting apparatus 1 that performs machining work of a turning type on the condition that the vibration cutting apparatus 1 has the above capability. Note that, in a first example, the rotation center of the to-be-cut object 6 coincides with the rotation center of the spindle 2a.

### First Example

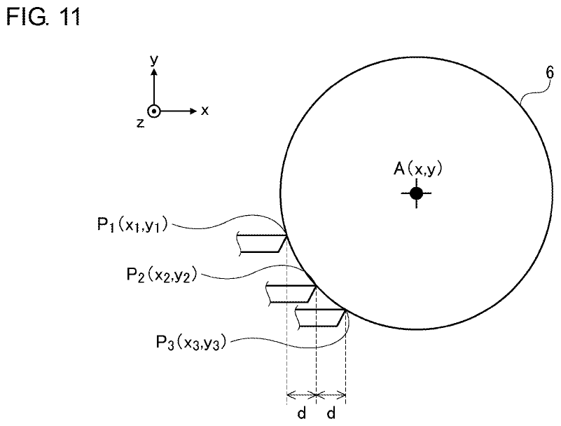

FIG. 11 is a diagram for describing a method for determining a relative positional relationship between the cutting tool and the rotation center of the to-be-cut object. A description will be given below of a method for calculating a rotation axis center A (x, y) of the to-be-cut object 6. In this example, the to-be-cut object 6 has been turned once. The to-be-cut object 6 is preferably rotated by the spindle 2a from the viewpoint of preventing a sharp tool cutting edge from being damaged, but the to-be-cut object 6 need not be rotated.

First, the movement controller 30 slowly moves the tool cutting edge from below to above (Y-axis positive direction) to bring the tool cutting edge into contact with the turned to-be-cut object 6 at the point P₁. Note that a coordinate x₁ of the point P₁ in the X-axis direction is preset, and a coordinate in the Y-axis direction is variable. The contact detection may be performed by the vibration controller 21 in accordance with the above-described method. The above contact detection method causes the positional relationship deriving part 28 to generate a regression line from changes in power consumption after contact to specify the contact position afterward. Therefore, at the moment when the movement controller 30 brings the tool cutting edge into contact with the point P₁, the positional relationship deriving part 28 has not yet specified the contact position, and although the tool cutting edge is actually in contact with the point P₁, the movement controller 30 needs to move the tool cutting edge slightly upward from the point P₁ (cutting is performed accordingly). Note that the positional relationship deriving part 28 detects the contact between the cutting tool 11 and the to-be-cut object 6 when the increase in ΔP_{b} exceeds the predetermined value and may detect the contact between the cutting tool 11 and the to-be-cut object 6 when the increase in ΔP_{b} that is equal to or greater than a noise amplitude is detected, for example.

When the positional relationship deriving part 28 derives the contact timing using the regression line, the movement controller 30 passes, to the positional relationship deriving part 28, the coordinates at the contact timing, that is, the coordinates (x₁, y₁) of the point P₁. When deriving the contact timing, the positional relationship deriving part 28 may cause the movement controller 30 to stop the movement of the vibration device 10. Strictly speaking, the movement controller 30 does not manage the coordinates of the cutting edge of the cutting tool 11, but manages the coordinates of the vibration device 10. However, the coordinates of the cutting edge and the coordinates of the vibration device have a one-to-one relation, and thus the following description will be given based on the coordinates of the cutting edge.

Note that, as described above, the to-be-cut object 6 that has been already turned is used. This aims at detecting the coordinates of the point P₁, and coordinates of the point P₂ and coordinates of the point P₃ to be described later on a circle having a uniform diameter centered on the rotation axis of the to-be-cut object 6, that is, the rotation axis of the spindle 2a. For this reason, the positional relationship deriving part 28 brings the tool cutting edge into contact with the turned to-be-cut object 6 at the point P₁, but coordinate values on the X axis and the Y axis during turning work performed as pre-machining work can be used as the point P₁.

Subsequently, the movement controller 30 moves the tool cutting edge downward (Y-axis negative direction in FIG. 11) by a sufficient distance and then moves the tool cutting edge forward in the X-axis positive direction by a known distance d. Thereafter, the movement controller 30 slowly moves the tool cutting edge upward (Y-axis positive direction) to bring the tool cutting edge into contact with the to-be-cut object 6 at the point P₂. When the positional relationship deriving part 28 detects the contact and derives the contact timing, the movement controller 30 passes, to the positional relationship deriving part 28, the coordinates at the contact timing, that is, the coordinates (x₂, y₂) of the point P₂.

Subsequently, the movement controller 30 moves the tool cutting edge downward (Y-axis negative direction) by a sufficient distance and then moves the tool cutting edge forward in the X-axis positive direction by the known distance d. Note that the distance by which the tool cutting edge is moved forward may be a known distance and may be different from an X-axis direction distance D between the coordinate of the point P₁ and the coordinate of the point P₂. Thereafter, the movement controller 30 slowly moves the tool cutting edge upward (Y-axis positive direction) to bring the tool cutting edge into contact with the to-be-cut object 6 at the point P₃. When the positional relationship deriving part 28 detects the contact and derives the contact timing, the movement controller 30 passes, to the positional relationship deriving part 28, the coordinates at the contact timing, that is, the coordinates (x₃, y₃) of the point P₃. Note that when the contact detection is performed while the spindle 2a is rotating, cutting is slightly made at the time of contact to reduce a radius, so that the contact detection at the points P₁, P₂, and P₃ is preferably performed at different positions in the Z-axis direction.

The positional relationship deriving part 28 determines the relative positional relationship between the cutting tool 11 and the rotation center of the to-be-cut object 6 based on coordinate values when the cutting tool 11 comes into contact with the to-be-cut object 6 at least at two positions different from a rotation angle position of the cutting tool 11 when the to-be-cut object 6 is turned. For example, when the coordinate values on the X axis and Y axis during turning work performed as pre-machining work are set as the point P₁, the positional relationship deriving part 28 determines the relative positional relationship between the cutting tool 11 and the rotation center of the to-be-cut object 6 based on the coordinate values of the point P₂ and P₃ that are rotation angle positions different from the point P₁. Note that, in the first example, the positional relationship deriving part 28 determines the relative positional relationship between the cutting tool 11 and the rotation center of the to-be-cut object 6 based on the coordinate values of three contact points that are different rotation angle positions, that is, the points P₁, P₂, and P₃. The positional relationship deriving part 28 calculates coordinates (x, y) of a point A serving as the rotation center of the to-be-cut object 6 and a radius R of the to-be-cut object 6 by using a fact that the three points are located on the same circle.

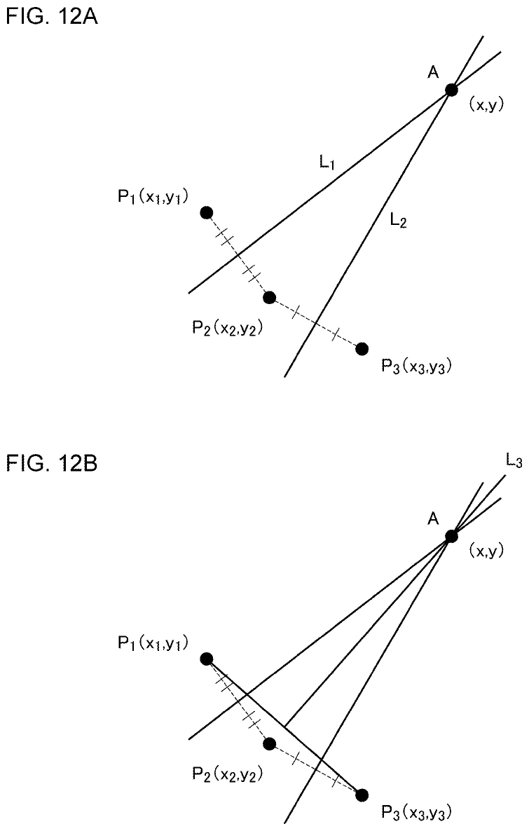

FIGS. 12A and 12B show a method for deriving the coordinates of the point A. As shown in FIG. 12A, coordinates A can be determined by calculating an intersection point of a line L1 and a line L2. The lines L1 and L2 are represented by the following (equation 5) and (equation 6), respectively:

$$\begin{matrix}{L}_{1} : y = - \frac{{x}_{1} - {x}_{2}}{{y}_{1} - {y}_{2}} ( x - \frac{{x}_{1} + {x}_{2}}{2} ) + \frac{{y}_{1} + {y}_{2}}{2} & ( EQUATION 5 ) \\ {L}_{2} : y = - \frac{{x}_{2} - {x}_{3}}{{y}_{2} - {y}_{3}} ( x - \frac{{x}_{2} + {x}_{3}}{2} ) + \frac{{y}_{2} + {y}_{3}}{2} & ( EQUATION 6 )\end{matrix}$$

(equation 7) is derived from (equation 5) and (equation 6):

$$( \frac{{x}_{2} - {x}_{3}}{{y}_{2} - {y}_{3}} - \frac{{x}_{1} - {x}_{2}}{{y}_{1} - {y}_{2}} ) x = \frac{{y}_{3} - {y}_{1}}{2} + \frac{{x}_{2}^{2} - {x}_{3}^{2}}{2 ( {y}_{2} - {y}_{3} )} - \frac{{x}_{1}^{2} - {x}_{2}^{2}}{2 ( {y}_{1} - {y}_{2} )} \qquad ( EQUATION 7 )$$

where x₁−x₂=−d and x₂−x₃=−d are satisfied, and when the coordinates (x₂, y₂) of the point P₂ is defined as (0, 0), an x coordinate of the point A is derived as follows:

$$x = \frac{{y}_{1} - {y}_{3}}{2 ( {y}_{1} + {y}_{3} )} ( d - \frac{{y}_{1} {y}_{3}}{d} ) \qquad ( EQUATION 8 )$$

A line L3 shown in FIG. 12B is represented by the following (equation 9):

$${L}_{3} : y = - \frac{{x}_{1} - {x}_{3}}{{y}_{1} - {y}_{3}} ( x - \frac{{x}_{1} + {x}_{3}}{2} ) + \frac{{y}_{1} + {y}_{3}}{2} \qquad ( EQUATION 9 )$$

When the x determined from (equation 8) is substituted into (equation 9), a y coordinate of the point A is derived as follows:

$$y = \frac{{y}_{1}^{2} + {y}_{3}^{2} + 2 {d}^{2}}{2 ( {y}_{1} + {y}_{3} )} \qquad ( EQUATION 10 )$$

Note that a rotation radius of the to-be-cut object 6 is determined as follows.

R=\sqrt{x²−y²} (EQUATION 11)

As described above, the positional relationship deriving part 28 derives the coordinates of the point A with the coordinates (x₂, y₂) of the point P₂ set to (0, 0). Accordingly, the positional relationship deriving part 28 determines the relative positional relationship between the cutting tool 11 and the rotation center of the to-be-cut object 6 based on the coordinate values of the three contact positions.

A consideration will be given below of the calculation accuracy of the coordinates of the point A and the radius R. In the first example, although a contact position detection error eₚ in the contact detection is calculated as shown in FIG. 10, an examination will be given below of the influence of the detection error eₚ on the accuracy of the coordinates of the point A and the radius R.

An error in the x coordinate is denoted by eₓ, an error in the y coordinate is denoted by e_{y}, and an error in the radius R is denoted by e_{R}.

That is, the errors will be examined based on:

\tilde{x}=x+eₓ, \tilde{y}=y+e_{y}, \tilde{R}=R+e_{R}

When the errors are examined in this way, the x coordinate value of the point A represented by (equation 8), the y coordinate value of the point A represented by (equation 10), and the radius R represented by (equation 11) are represented as follows:

$$\tilde{x} = \frac{{\tilde{y}}_{1} - {\tilde{y}}_{3}}{2 ( {\tilde{y}}_{1} + {\tilde{y}}_{3} )} ( d - \frac{{\tilde{y}}_{1} {\tilde{y}}_{3}}{d} ) , \\ \tilde{y} = \frac{{\tilde{y}}_{1}^{2} + {\tilde{y}}_{3}^{2} + 2 {d}^{2}}{2 ( {\tilde{y}}_{1} + {\tilde{y}}_{3} )}$$

$$\tilde{R} = \sqrt{{\tilde{x}}^{2} + {\tilde{y}}^{2}}$$

When the error eₓ is determined as follows:

$${e}_{x} = \frac{{y}_{1} + {e}_{p 1} - {y}_{3} - {e}_{p 3}}{2 ( {y}_{1} + {e}_{p 1} + {y}_{3} + {e}_{p 3} )} ( d - \frac{( {y}_{1} + {e}_{p 1} ) ( {y}_{3} + {e}_{p 3} )}{d} ) - \frac{{y}_{1} - {y}_{3}}{2 ( {y}_{1} + {y}_{3} )} ( d - \frac{{y}_{1} {y}_{3}}{d} ) = \frac{{y}_{1} - {y}_{3}}{2 d ( {y}_{1} + {y}_{3} )} ( {y}_{1} {y}_{3} - ( {y}_{1} + {e}_{p 1} ) ( {y}_{3} + {e}_{p 3} ) ) ,$$

wherein approximation can be made as follows:

$$\frac{{e}_{p 1} + {e}_{p 3}}{{y}_{1} + {y}_{3}} \approx 0 \& {e}_{p} = {e}_{p 1} = {e}_{p 3} \& \frac{{e}_{p 1}}{{y}_{1} + {y}_{3}} \approx 0 ,$$

and

therefore, the error ex is derived as follows:

$${e}_{x} \approx \frac{{y}_{1} - {y}_{3}}{2 d} {e}_{p}$$

Similarly, when the error e_{y} is determined,

$$\begin{matrix}{e}_{y} = \frac{1}{2 ( {y}_{1} + {y}_{3} )} \{ \begin{matrix}\frac{\{ {( {y}_{1} + {e}_{p 1} )}^{2} + {( {y}_{3} + {e}_{p 3} )}^{2} + 2 {d}^{2} \}}{1 + \frac{{e}_{p 1} + {e}_{p 3}}{2 ( {y}_{1} + {y}_{3} )}} - \\ \{ {y}_{1}^{2} + {y}_{3}^{2} + 2 {d}^{2} \}\end{matrix} \} \\ = \frac{1}{2 ( {y}_{1} + {y}_{3} )} \{ 2 {y}_{1} {e}_{p 1} + 2 {y}_{3} {e}_{p 3} + {e}_{p 1}^{2} + {e}_{p 3}^{2} \}\end{matrix}$$

wherein approximation can be made as follows:

$$\frac{{e}_{p 1} + {e}_{p 3}}{2 ( {y}_{1} + {y}_{3} )} \approx 0 \& \frac{{e}_{p 1}^{2} + {e}_{p 3}^{2}}{2 ( {y}_{1} + {y}_{3} )} \approx 0 \& {e}_{p} = {e}_{p 1} = {e}_{p 3}$$

therefore, the error e_{y} is derived as follows:

e_{y}≈eₚ

The error e_{R} is represented as follows:

e_{R}≈\sqrt{eₓ²+e_{y}²}

As described above, the error eₓ in the x coordinate, the error e_{y} in the y coordinate, and the error e_{R} in the radius R can all be represented by the contact position detection error eₚ, and it was confirmed that a reduction in contact position detection error eₚ allows an increase in machining accuracy.

As described in the first example, when the relative position between the cutting tool 11 and the rotation center of the to-be-cut object 6 (center of the spindle) is successfully specified, a cylindrical surface of the to-be-cut object 6 can be finished to have an accurate diameter, and a so-called navel for preventing a center height of the tool cutting edge from being misaligned is not left at the time of machining of an end surface, making it possible to achieve high accuracy in machining of a spherical or aspherical surface.

### Second Example

In the first example, the positional relationship deriving part 28 detects the contact between the cutting tool 11 and the turned to-be-cut object 6 to specify the contact position. In a second example, the positional relationship deriving part 28 may detect contact between the cutting tool 11 and a reference surface defined on a component to which the to-be-cut object 6 is attached and specify a relative position of the cutting tool 11 with respect to the component reference surface. Examples of the component may include the spindle 2a that supports the to-be-cut object 6, for example, and the positional relationship deriving part 28 may specify a contact position between the cutting tool 11 and the spindle 2a by bringing the cutting tool 11 into contact with the reference surface defined on an end surface or peripheral surface of the spindle 2a and derive a relative positional relationship between the cutting tool 11 and an attachment surface, rotation center, or the like of the to-be-cut object 6.

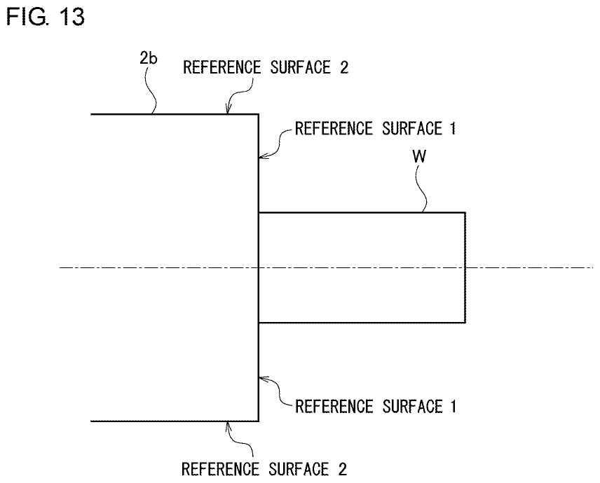

FIG. 13 is a diagram for describing the reference surface. Set as the reference surface is a surface whose relative positional relationship with the attachment surface, rotation center, or the like of the workpiece W is known. In the present example, in the cutting apparatus that rotate the workpiece W about the center axis and turns the workpiece W, an end surface of a spindle 2b to which the workpiece W is fixed is defined as a reference surface 1, and a peripheral surface of the spindle 2b is defined as a reference surface 2. That is, the reference surface 1 is a surface orthogonal to a spindle rotation axis, and the reference surface 2 is a cylindrical surface centered on the spindle rotation center. The positional relationship deriving part 28 determines the relative positional relationship between the cutting tool and the attachment surface, rotation center, or the like of workpiece W based on a coordinate value of the contact position on the reference surface whose relative positional relationship with the attachment surface, rotation center, or the like of the workpiece W is known.

As described above, the positional relationship deriving part 28 can detect the contact between the cutting tool 11 and the spindle 2b serving as a component to specify the contact position.

Herein, the positional relationship deriving part 28 detects the contact of the tool cutting edge with the reference surface 1 to find out an accurate origin of the tool cutting edge (relative position of the tool cutting edge with respect to the attachment surface of the workpiece W, that is, a left-end surface of the workpiece W) in a longitudinal direction of the workpiece W (left-right direction in FIG. 13). This in turn allows, at the time of machining of the end surface of the workpiece W (right-end surface in FIG. 13), the workpiece W to be finished to have an accurate length (length in the left-right direction). Further, the positional relationship deriving part 28 detects the contact of the tool cutting edge with the reference surface 2 at three points (or two points if the diameter is known) that are different from each other in Y-axis position as in the first example to find out an accurate origin of the tool cutting edge in the radial direction of the workpiece W (relative position of the tool cutting edge with respect to the rotation center of the workpiece W). This in turn allows, at the time of machining of the cylindrical surface of the workpiece W, the workpiece W to be finished to have an accurate diameter.

The reference surface may be defined on part of the workpiece W. For example, in FIG. 13, when the reference surface 1 is part of the workpiece W, the workpiece W can be accurately finished by length from the surface to the right-end surface of the workpiece W. Note that FIG. 13 shows an example of turning work, but, in a case of planing work, contact detection made at three points on the reference surface (accurate flat surface) can specify the flat surface, allowing a surface parallel to the reference surface to be finished to have an accurate height. Further, when the reference surface is a surface accurately orthogonal to the Z axis, contact detection made only at one point allows a surface parallel to a bottom surface (surface of the workpiece W that is in contact with the reference surface) to be finished to have an accurate height.

In the following third to thirteenth examples, a description will be given of techniques based on the three-point contact detection mainly described in the first example. In the drawings to be referenced for the description, the A axis denotes a rotation axis centered on the X axis, the B axis denotes a rotation axis centered on the Y axis, and the C axis denotes a rotation axis centered on the Z axis. Further, in this specification and drawings, regarding a symbol with a caret (hat), for example, when the symbol is “y”, it should be noted that, due to restriction on representation, the symbol is represented as follows: That is, the symbol y having a caret (hat) attached thereon and the symbol y having a caret attached to a side thereof indicate the same variable. In the examples, a symbol with a caret means a variable to be obtained. Note that the symbol having a caret attached thereon is used in mathematical expressions, and the symbol having a caret attached to a side thereof is used in sentences. It should also be noted that symbols used in the drawings of different examples are used for the understanding of each example.

### Third Example

In the first example, the controller 20 specifies the relative positional relationship between the cutting tool 11 and the rotation center of the to-be-cut object 6 based on the coordinate values of the three points on the turned to-be-cut object 6, in other words, pre-machined workpiece. In the third example, the controller 20 determines the relative positional relationship between the cutting tool 11 and an object that has a known shape and has been machined with high accuracy for the origin setting of the cutting edge to specify information on the cutting edge of the cutting tool 11. Hereinafter, an object used for specifying information on the cutting edge of the cutting tool 11 is referred to as a “reference block”. In order to identify the cutting edge position by bringing the cutting edge of the cutting tool 11 into contact with the reference block, the controller 20 grasps, as a precondition, at least a shape of the reference block serving as a contact target.

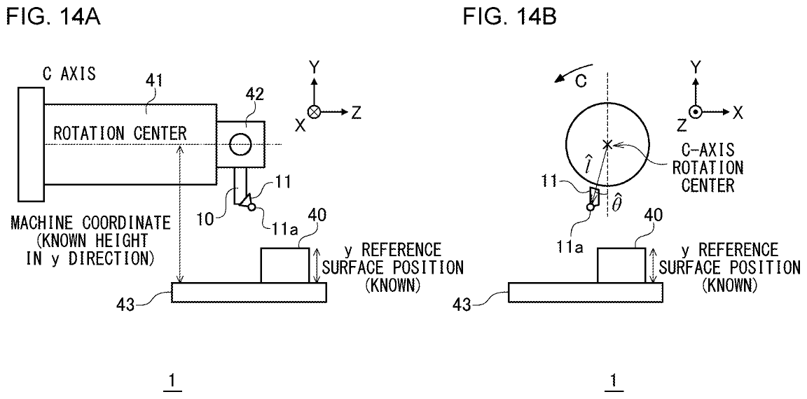

FIGS. 14A-14B show an example of the vibration cutting apparatus 1 in which the vibration device 10 is attached rotatable around the C axis. FIG. 14A shows the vibration cutting apparatus 1 viewed from the X-axis direction, and FIG. 14B shows the vibration cutting apparatus 1 viewed from the Z-axis direction. The cutting tool 11 is attached to the tip of the vibration device 10, and the vibration device 10 is supported by a support device 42. The support device 42 is fixed to the attachment spindle 41 so as to be rotatable about the C axis.

A reference block 40 serving as the object having a known shape is placed on a B-axis table 43. In the third example, in order to specify the cutting edge position of the cutting tool 11 after the attachment of the cutting tool 11 to the vibration device 10, the controller 20 brings the cutting edge into contact with the reference block 40 at least three times and uses the position coordinates of the contact points to specify information on the attachment position of the cutting tool 11. In the third example, the feed mechanism 7 has a capability of moving the B-axis table 43, and the movement controller 30 moves the B-axis table 43 to bring the cutting edge 11a of the cutting tool 11 and a portion having the known shape of the reference block 40 into contact with each other at a plurality of points. The reference block 40 is made of a material that is high in hardness to be less prone to damage from the contact of the cutting edge 11a. In the third example, a nose radius of the cutting edge 11a, center coordinates of a round portion of the cutting edge, and an error in shape of the cutting edge are unknown, and a description will be given of a method for specifying these pieces of information. Hereinafter, it is assumed that the tip of the cutting edge 11a has a certain curvature (nose radius), and the center of the round portion of the cutting edge is sometimes referred to as “tool center”.

In the YZ plane shown in FIG. 14A, the nose radius R\hat{ } and the tool center (z\hat{ }, y\hat{ }) in the YZ plane are determined.

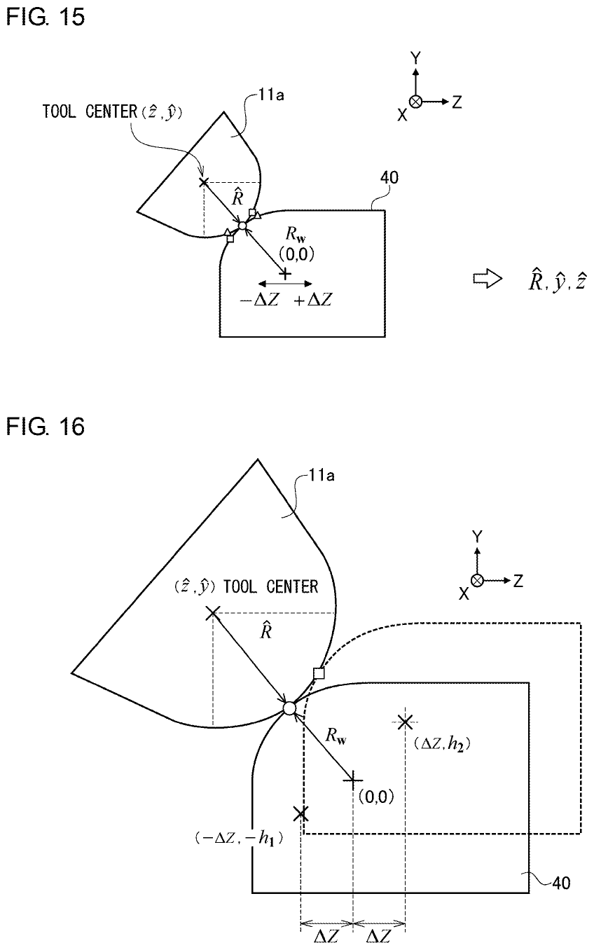

FIG. 15 shows a state where the cutting edge 11a and the portion having the known shape of the reference block 40 are in contact with each other at one point. As described above, the cutting edge 11a has an arc surface having a certain curvature and the nose radius R\hat{ }. Note that the nose radius R\hat{ } is unknown. On the other hand, the reference block 40 comes into contact with the cutting edge 11a using the portion whose shape is known. That a shape is known in the third example means that the positional relationship deriving part 28 recognizes a shape of a portion where the cutting edge 11a may come into contact with.

The reference block 40 needs to have at least a portion with a known shape that comes into contact with the cutting edge 11a, and the positional relationship deriving part 28 need not recognize a shape of a portion that is less likely to come into contact with the cutting edge 11a. In the example shown in FIG. 15, the reference block 40 has an arc surface having a radius Rw centered on a position denoted by “+”, and the positional relationship deriving part 28 recognizes that the cutting edge 11a comes into contact with the arc surface when the origin of the cutting edge 11a is set. In other words, when the origin is set, the movement controller 30 controls the feed mechanism 7 to move the B-axis table 43 such that the cutting edge 11a is brought into contact with the arc surface having the known shape of the reference block 40. Shape data of the arc surface may be stored in a memory (not shown).

The movement controller 30 slowly moves the B-axis table 43 from below to above (Y-axis positive direction) toward the cutting edge 11a of the cutting tool 11. In FIG. 15, the cutting edge 11a and the reference block 40 are in contact with each other at a contact point denoted by a circle. At this time, the positional relationship deriving part 28 defines coordinates of the rotation center position “+” of the arc of the reference block 40 as (0, 0). The contact detection may be performed by the vibration controller 21 in accordance with the above-described method.

Thereafter, the movement controller 30 brings the reference block 40 into contact with the cutting edge 11a at a position that results from shifting the initial contact position serving as a reference by +ΔZ and −ΔZ in the Z-axis direction. In any of the above cases, the position of the reference block 40 that comes into contact with the cutting edge 11a is located on the arc surface having the radius Rw. Specifically, from the state shown in FIG. 15, the movement controller 30 lowers the reference block 40 by a sufficient distance in the Y-axis negative direction, moves the reference block 40 by ΔZ in the Z-axis negative direction, and then slowly moves the reference block 40 in the Y-axis positive direction to bring the arc surface of the reference block 40 into contact with the cutting edge 11a. A contact point at this time is denoted by a triangle in FIG. 15. Subsequently, the movement controller 30 lowers the reference block 40 by a sufficient distance in the Y-axis negative direction, moves the reference block 40 by 2ΔZ in the Z-axis positive direction, and then slowly moves the reference block 40 in the Y-axis positive direction to bring the arc surface of the reference block 40 into contact with the cutting edge 11a. A contact point at this time is denoted by a square in FIG. 15. Note that, in the second movement, the movement in the Y-axis negative direction may be omitted.

As described above, the movement controller 30 brings the cutting edge 11a of the cutting tool 11 and the portion having the known shape of the reference block 40 into contact with each other at least at three points and passes, to the positional relationship deriving part 28, the coordinate values of the contact positions. The positional relationship deriving part 28 specifies the information on the attachment position of the cutting tool 11 based on the respective coordinate values of the contact positions.

FIG. 16 shows a positional relationship between the cutting edge 11a and the reference block 40. When contact is made at the contact point denoted by a square shown in FIG. 15, coordinates of a center of the known arc become (ΔZ, h2). h2 denotes a value detected by the movement controller 30. Further, when contact is made at the contact point denoted by a triangle shown in FIG. 15, the coordinates of the center of the known arc become (−ΔZ, −h1). h1 also denotes a value detected by the movement controller 30.

As shown in FIG. 16, defining the radius center of the arc surface of the reference block 40 at the time of the first contact as (0, 0) and the tool center as (z\hat{ }, y\hat{ }) results in:

\hat{z}²+ŷ²=(\hat{R}+R_{w})²

(\hat{z}+ΔZ)²+(ŷ+h₁)²=(\hat{R}+R_{w})²

(\hat{z}+ΔZ)²+(ŷ+h₂)²=(\hat{R}+R_{w})²,

and

simultaneously satisfying the equations results in:

$$\hat{y} = \frac{2 Δ {Z}^{2} + {h}_{1}^{2} + {h}_{2}^{2}}{2 ( {h}_{2} - {h}_{1} )}$$

$$\hat{z} = - \frac{( Δ {Z}^{2} + {h}_{1} {h}_{2} ) ( {h}_{1} + {h}_{2} )}{2 Δ Z ( {h}_{2} - {h}_{1} )}$$

R\hat{ } is determined based on z\hat{ } and y\hat{ } obtained from the above equations.

\hat{R}=\sqrt{\hat{x}²+ŷ²}−R_{w}

As described above, the positional relationship deriving part 28 specifies the information on the attachment position of the cutting tool 11 based on the coordinate values of the three contact positions. Specifically, the positional relationship deriving part 28 determines the nose radius R of the cutting edge and the tool center coordinates (z, y) as the information on the attachment position.

Note that when the reference block 40 having the known arc shape comes into contact with at least one point on the arc other than the above three contact positions, a deviation from the contact position estimated from the nose radius R and the tool center coordinates (z, y) determined as described above is determined as a deviation (error) from the arc having the nose radius R of the cutting edge.

Next, the positional relationship deriving part 28 calculates a distance l\hat{ } from the C-axis rotation center to the tip of the cutting edge 11a and an initial attachment angle θ\hat{ } in the XY plane shown in FIG. 14B. For example, for machining a complicated free-curved surface, cutting feed performed by simultaneously controlling the XYC axes and pick feed in the Z-axis direction may be repeated. Thus, when the C axis is included in the cutting feed movement, errors in the distance l\hat{ } from the C-axis rotation center to the tip of the cutting edge 11a and the initial attachment angle θ\hat{ } leads to a reduction in machining accuracy. Therefore, the positional relationship deriving part 28 specifies the information on the attachment position of the cutting tool 11 based on the contact coordinate values of at least three points where the cutting edge 11a comes into contact with the portion having the known shape of the reference block 40 when the cutting edge 11a is moved in the XY plane.

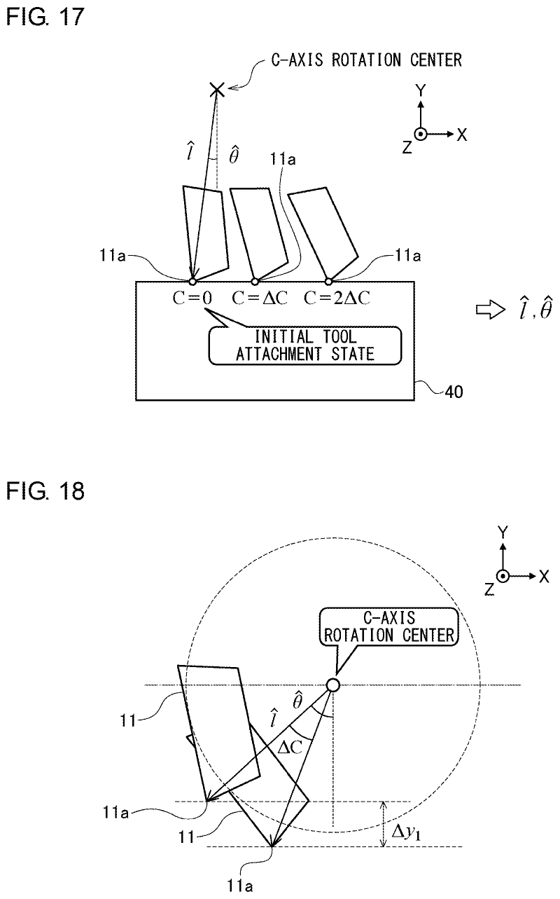

FIG. 17 schematically shows a state where the cutting tool 11 is inclined when the cutting tool 11 is rotated counterclockwise to bring the cutting edge 11a into contact with an upper surface (y reference surface) of the reference block 40. The movement controller 30 controls the feed mechanism 7 to rotate the cutting tool 11 around the C axis. The upper surface of the reference block 40 is parallel to a plane orthogonal to the Y axis, and a position of the upper surface of the reference block 40 is known as shown in FIG. 14B.

The movement controller 30 slowly moves the B-axis table 43 from below to above (Y-axis positive direction) toward the cutting edge 11a of the cutting tool 11 to bring the upper surface of the reference block 40 into contact with the cutting edge 11a. Thereafter, the movement controller 30 lowers the reference block 40 by a sufficient distance in the Y-axis negative direction, rotates the cutting tool 11 counterclockwise by ΔC, and then slowly moves the reference block 40 in the Y-axis positive direction to bring the upper surface of the reference block 40 into contact with the cutting edge 11a. Subsequently, the movement controller 30 lowers the reference block 40 by a sufficient distance in the Y-axis negative direction, further rotates the cutting tool 11 counterclockwise by ΔC, and then slowly moves the reference block 40 in the Y-axis positive direction to bring the upper surface of the reference block 40 into contact with the cutting edge 11a. This causes the positional relationship deriving part 28 to acquire heights in the Y-axis direction (y positions) at the three contact positions.

FIG. 18 shows a change in height Δy1 of the contact position when rotation is made by ΔC from the initial contact position (initial y position). With the first contact position set as a reference, a change in height of the contact position when rotation is further made by ΔC is denoted by Δy2. At this time, the following equations are satisfied for Δy1 and Δy2.

Δ_{y1}=\hat{l} cos(\hat{θ}−ΔC)−\hat{l} cos \hat{θ}

Δ_{y2}=\hat{l} cos(\hat{θ}−2ΔC)−\hat{l} cos \hat{θ}

Simultaneously satisfying both the equations to remove l\hat{ } results in

$$Δ {y}_{1} / Δ {y}_{2} = \frac{cos ( \hat{θ} - Δ C ) - cos \hat{θ}}{cos ( \hat{θ} - 2 Δ C ) - cos \hat{θ}}$$

$$\hat{θ} = {tan}^{- 1} ( \frac{Δ {y}_{2} ( 1 - cos Δ C ) - Δ {y}_{1} ( 1 - cos 2 Δ C )}{Δ {y}_{1} sin 2 Δ C + Δ {y}_{2} sin Δ C} ) ,$$

and

l\hat{ } is determined using obtained θ\hat{ } as follows:

$$\hat{l} = \frac{Δ {y}_{1}}{cos ( \hat{θ} - Δ C ) - cos \hat{θ}}$$

As described above, the positional relationship deriving part 28 acquires the information on the initial attachment position of the cutting tool 11 based on the coordinate values of the three contact positions for the rotation about the C axis. Specifically, the positional relationship deriving part 28 derives the distance l from the C-axis rotation center to the cutting edge 11a and the initial attachment angle θ as the information on the attachment position. As described above, in the third example, the use of the reference block 40 allows the positional relationship deriving part 28 to specify the information on the attachment position with high accuracy.

### Fourth Example

In a fourth example as well, the controller 20 determines, using an object (reference block 40) with a known shape that has been machined with high accuracy for the origin setting of the cutting edge, the relative positional relationship between the cutting tool 11 and the reference block 40 to specify the information on the attachment position of the cutting tool 11.

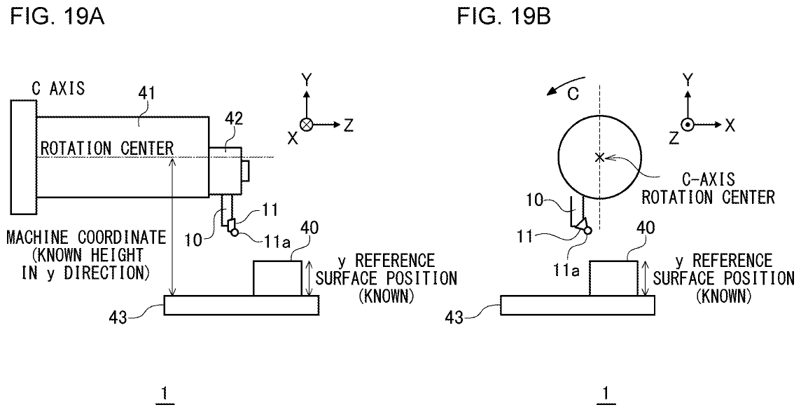

FIGS. 19A-19B show another example of the vibration cutting apparatus 1 in which the vibration device 10 is attached rotatable around the C axis. FIG. 19A shows the vibration cutting apparatus 1 viewed from the X-axis direction, and FIG. 19B shows the vibration cutting apparatus 1 viewed from the Z-axis direction. The cutting tool 11 is attached to the tip of the vibration device 10, and the vibration device 10 is supported by a support device 42. The support device 42 is fixed to the attachment spindle 41 so as to be rotatable about the C axis.

A reference block 40 serving as the object having a known shape is placed on a B-axis table 43. In the fourth example as well, in order to specify the cutting edge position of the cutting tool 11 after the attachment of the cutting tool 11 to the vibration device 10, the controller 20 brings the cutting edge into contact with the reference block 40 at least three times and uses the position coordinates of the contact points to specify information on the attachment position of the cutting tool 11. In the fourth example, as in the third example, the movement controller 30 moves the B-axis table 43 to bring the cutting edge 11a of the cutting tool 11 and the portion having the known shape of the reference block 40 into contact with each other at a plurality of points.

First, a description will be given of a method for determining the nose radius R\hat{ } and the tool center (x\hat{ }, y\hat{ }) in the XY plane.

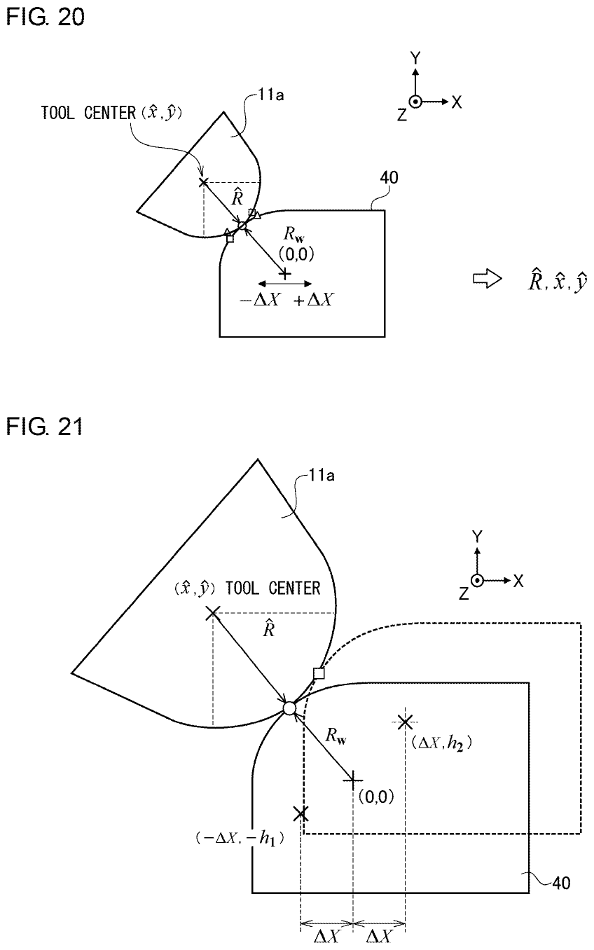

FIG. 20 shows a state where the cutting edge 11a and the portion having the known shape of the reference block 40 are in contact with each other at one point. The cutting edge 11a has an arc surface having a certain curvature and the nose radius R\hat{ }. The nose radius R\hat{ } is unknown. The reference block 40 comes into contact with the cutting edge 11a using the portion whose shape is known. That a shape is known means that the positional relationship deriving part 28 recognizes a shape of a portion where the cutting edge 11a may come into contact with.

In the example shown in FIG. 20, the reference block 40 has an arc surface having a radius Rw centered on a position denoted by “+”, and the positional relationship deriving part 28 recognizes that the cutting edge 11a comes into contact with the arc surface when the origin of the cutting edge 11a is set. In other words, when the origin is set, the movement controller 30 controls the feed mechanism 7 to move the B-axis table 43 such that the cutting edge 11a is brought into contact with the arc surface having the known shape of the reference block 40. Shape data of the arc surface may be stored in a memory (not shown).

The movement controller 30 slowly moves the B-axis table 43 from below to above (Y-axis positive direction) toward the cutting edge 11a of the cutting tool 11. In FIG. 20, the cutting edge 11a and the reference block 40 are in contact with each other at a contact point denoted by a circle. At this time, the positional relationship deriving part 28 defines coordinates of the rotation center position “+” of the arc of the reference block 40 as (0, 0).

Thereafter, the movement controller 30 brings the reference block 40 into contact with the cutting edge 11a at a position that results from shifting the initial contact position serving as a reference by +ΔX and −ΔX in the X-axis direction. In any of the above cases, the position of the reference block 40 that comes into contact with the cutting edge 11a is located on the arc surface having the radius Rw. Specifically, from the state shown in FIG. 20, the movement controller 30 lowers the reference block 40 by a sufficient distance in the Y-axis negative direction, moves the reference block 40 by ΔX in the X-axis negative direction, and then slowly moves the reference block 40 in the Y-axis positive direction to bring the arc surface of the reference block 40 into contact with the cutting edge 11a. A contact point at this time is denoted by a triangle in FIG. 15. Subsequently, the movement controller 30 lowers the reference block 40 by a sufficient distance in the Y-axis negative direction, moves the reference block 40 by 2ΔX in the X-axis positive direction, and then slowly moves the reference block 40 in the Y-axis positive direction to bring the arc surface of the reference block 40 into contact with the cutting edge 11a. A contact point at this time is denoted by a square in FIG. 15. Note that, in the second movement, the movement in the Y-axis negative direction may be omitted.

As described above, the movement controller 30 brings the cutting edge 11a of the cutting tool 11 and the portion having the known shape of the reference block 40 into contact with each other at least at three points and passes, to the positional relationship deriving part 28, the coordinate values of the contact positions. The positional relationship deriving part 28 specifies the information on the attachment position of the cutting tool 11 based on the respective coordinate values of the contact positions.

FIG. 21 shows the positional relationship between the cutting edge 11a and the reference block 40. When contact is made at the contact point denoted by a square shown in FIG. 20, coordinates of a center of the known arc become (ΔX, h2). h2 denotes a value detected by the movement controller 30. Further, when contact is made at the contact point denoted by a triangle shown in FIG. 20, the coordinates of the center of the known arc become (−ΔX, −h1). h1 also denotes a value detected by the movement controller 30.

As shown in FIG. 21, defining the radius center of the arc surface of the reference block 40 at the first contact as (0, 0) and the tool center as (x\hat{ }, y\hat{ }) results in:

\hat{x}²+ŷ²=(\hat{R}+R_{w})²

(\hat{x}+ΔX)²+(ŷ+h₁)²=(\hat{R}+R_{w})²

(\hat{x}+ΔX)²+(ŷ+h₂)²=(\hat{R}+R_{w})²,

and

simultaneously satisfying the equations results in:

$$\hat{y} = \frac{2 Δ {X}^{2} + {h}_{1}^{2} + {h}_{2}^{2}}{2 ( {h}_{2} - {h}_{1} )}$$

$$\hat{x} = - \frac{( Δ {X}^{2} + {h}_{1} {h}_{2} ) ( {h}_{1} + {h}_{2} )}{2 Δ X ( {h}_{2} - {h}_{1} )}$$

R\hat{ } is determined based on x\hat{ } and y\hat{ } determined from the above equations.

\hat{R}=\sqrt{\hat{x}²+ÿ²}−R_{w}

As described above, the positional relationship deriving part 28 specifies the information on the attachment position of the cutting tool 11 based on the coordinate values of the three contact positions. Specifically, the positional relationship deriving part 28 determines the nose radius R of the cutting edge and the tool center coordinates (x, y) as the information on the attachment position.

Next, the positional relationship deriving part 28 determines a z coordinate of the cutting edge 11a.

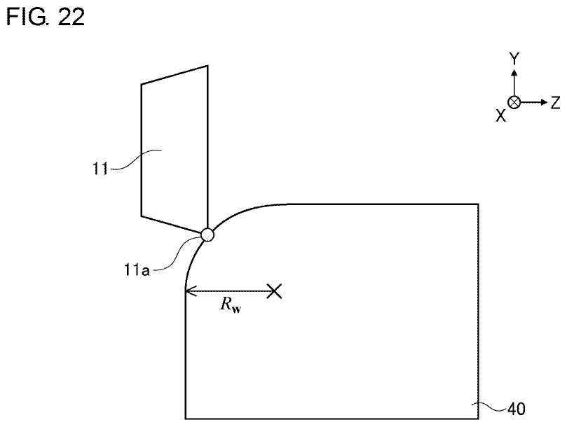

FIG. 22 shows a state where the portion having the known shape of the reference block 40 is brought into contact with the cutting edge 11a of the cutting tool 11. The positional relationship deriving part 28 acquires a z coordinate value at this time to specify a tip point of the cutting edge.

Note that the movement controller 30 needs to move the reference block 40 to bring the known arc surface of the reference block 40 and the cutting edge 11a into contact with each other. For example, when the reference block 40 is moved, the arc surface of the reference block 40 may come into contact with a rake face of the cutting tool 11 before coming into contact with the cutting edge 11a. In the illustrated example, when an angle of the rake face in the initial attachment state is less than 90 degrees with respect to the Z axis, depending on the position of the reference block 40 in the Z-axis direction, the arc surface of the reference block 40 and the rake face of the cutting tool 11 may come into contact with each other to prevent the arc surface of the reference block 40 from coming into contact with the cutting edge 11a. At this time, it is preferable that the movement controller 30 shift the reference block 40 in the Y-axis negative direction to allow the cutting edge 11a to come into contact with an upper side of the known arc surface.

As described above, in the fourth example, the use of the reference block 40 allows the positional relationship deriving part 28 to specify the information on the attachment position with high accuracy.

### Fifth Example

When an error is present in the attachment of the cutting tool 11, the to-be-cut object 6 subjected to cutting work has a shape different from an originally designed shape. For this reason, in a fifth example, a difference between a machined surface of the actually turned to-be-cut object 6 and a machined surface of the ideally turned to-be-cut object 6 (that is, a machined surface as designed) is used to specify an attachment error (Δx\hat{ }, Δy\hat{ }, Δz\hat{ }) in the tool center. Once the attachment error in the tool center can be specified, a feed path of the cutting tool 11 whose attachment error thus specified has been corrected can be calculated. In the fifth example, the movement controller 30 moves the vibration device 10 relative to the to-be-cut object 6 subjected to cutting work using the feed capability of the feed mechanism 7 in a movement direction not used for the cutting and specifies the attachment error of the tool cutting edge based on the coordinate values of at least two positions where the cutting tool 11 comes into contact with the to-be-cut object 6.

Hereinafter, the machined surface of the to-be-cut object 6 that has been turned to derive an error may be referred to as a “pre-machined surface” or “already machined surface”. Note that making the pre-machined surface thicker than a final finished surface allows finishing work for obtaining the final finished surface to be made along the corrected feed path. In other words, it is only necessary that, after semi-finishing work before the final finishing work, the attachment error is specified using the machined surface.

The controller 20 determines the attachment error of the cutting tool 11 based on the coordinate values of at least three points on the pre-machined surface of the to-be-cut object 6. When the coordinate value of one point acquired during cutting work on the pre-machined surface is used, the controller 20 may acquire the coordinate values of at least two points where the cutting tool 11 is brought into contact with the pre-machined surface at positions different from the rotation angle position of the cutting tool 11 during turning work to determine the attachment error in the cutting tool 11. That is, the controller 20 may acquire the coordinate values of the at least two points where the cutting tool 11 is brought into contact with the pre-machined surface at different y positions to determine the attachment error in the cutting tool 11.

With a consideration given to the possibility that the accuracy of the coordinate value acquired during pre-machining work and the accuracy of the coordinate value acquired at the time of contact with the pre-machined surface may be slightly different from each other, the controller 20 may use, rather than the coordinate value acquired during pre-machining work, the coordinate values of at least three points where the cutting tool 11 is brought into contact with the pre-machined surface at different y positions to determine the attachment error in the cutting tool 11.

Note that, as described in the first example, when the coordinate value of the contact point is acquired, the to-be-cut object 6 may be rotated from the viewpoint of preventing the cutting edge 11a from being damaged. In this case, since the contact point is slightly grooved, it is preferable to slightly shift the z position within a range where the z position can be regarded as being substantially uniform when acquiring the coordinate value of the next contact point. An example where the controller 20 determines the attachment error using the coordinate values of three points will be given below, but, in order to increase the detection accuracy of the attachment error, coordinate values of four or more points may be used.

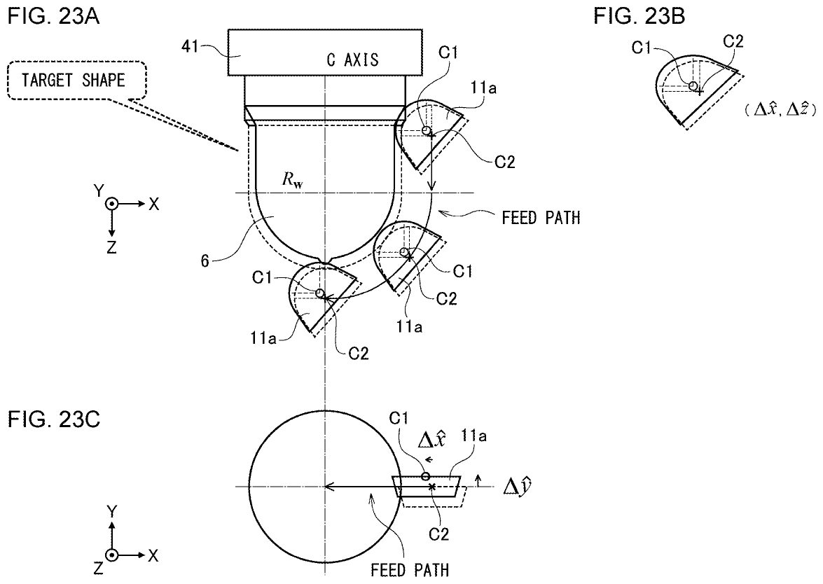

FIG. 23A shows a state where the to-be-cut object 6 is machined into a shape having a cylindrical surface and a hemispherical surface. The to-be-cut object 6 is rotatably supported on the attachment spindle 41. In the fifth example, the cutting tool 11 is attached to the vibration device 10 with an attachment error (Δx\hat{ }, Δy\hat{ }, Δz\hat{ }).

FIG. 23B shows an attachment error (Δx\hat{ }, Δz\hat{ }) in the ZX plane. C2 denotes an ideal tool center position, and C1 denotes a tool center position containing an error. FIG. 23C shows an attachment error (Δx\hat{ }, Δy\hat{ }) in the XY plane.

In FIG. 23A, a feed path represented by an arrow is a path through which the ideal center C2 passes. In the NC machine tool, the feed path is calculated on the assumption that the tool center is located at C2. The movement controller 30 uses the feed capability of the feed mechanism 7 in the Z-axis translation direction and the C-axis rotation direction to machine the to-be-cut object 6 using the cutting tool 11. In FIG. 23A, the dotted line represents an ideal machined surface when the tool center is located at C2. For this turning work, it is predetermined as a design value that machining work is performed to form the cylindrical surface having the radius Rw.

However, in a case where the actual tool center is located at C1 containing an attachment error, when the movement controller 30 moves the cutting tool 11 along the calculated feed path, a machined surface represented by a solid line is formed.

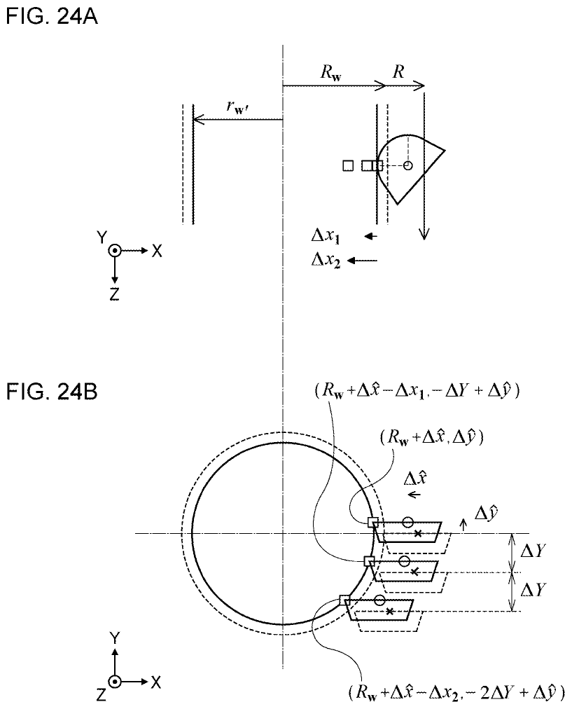

FIGS. 24A and 24B are diagrams for describing a method for deriving an attachment error (Δx\hat{ }, Δy\hat{ }) in the tool center. Due to the attachment error (Δx\hat{ }, Δy\hat{ }) in the XY plane, the radius Rw of the cylindrical surface become rw′ rather than Rw. The movement controller 30 moves the vibration device 10 relative to the to-be-cut object 6 subjected to cutting work (the cut to-be-cut object 6) using the feed capability of the feed mechanism 7 in a movement direction not used for the cutting and acquires the coordinate values of at least two positions where the cutting tool 11 comes into contact with the to-be-cut object 6. In the fifth example, the movement controller 30 uses the feed capability of the feed mechanism 7 in an X-axis translation direction and Y-axis translation direction to acquire a plurality of contact coordinate values.

Even when the cutting tool 11 is brought into contact with the pre-machined surface by using the feed capability of the feed mechanism 7 in the same movement direction as for the pre-machining work, the contact is theoretically made at the same coordinate position as during the machining work. Therefore, in the fifth example, in order to derive the attachment error in the tool center by the contact between the pre-machined surface and the cutting tool 11, a feed capability of the feed mechanism 7 that is different in movement direction from the feed capability used for the pre-machining work is used to bring the cutting tool 11 into contact with the pre-machined surface. In other words, the contact position of the cutting tool 11 is derived using a feed capability other than the feed capability in the movement direction required for the pre-machining work. As described above, the movement controller 30 uses a feed capability along a ZC axis for the pre-machining work to acquire the coordinates of the contact point, but uses a feed capability along an XY axis for attachment error estimation process.

As described in the first example, the positional relationship deriving part 28 acquires the coordinate values of three points on the cylindrical surface.

In FIGS. 24A and 24B, squares denote points on the cylindrical surface, and the points are represented as follows:

Point 1: (Rw+Δx\hat{ }, Δy\hat{ }),

Point 2: (Rw+Δx\hat{ }−Δx1, −ΔY+Δy\hat{ }), and

Point 3: (Rw+Δx\hat{ }−Δx2, −2ΔY+Δy\hat{ }). Δx1 and Δx2 are values detected by the movement controller 30.

Note that the coordinate value represented as the point 1 in this example is based on coordinates acquired during pre-machining work, but the movement controller 30 may bring the cutting edge 11a into contact with the cylindrical surface at three points to acquire the coordinate values of the three points. At this time, from the viewpoint of preventing the cutting edge 11a from being damaged, when the to-be-cut object 6 is rotated, it is preferable that the movement controller 30 bring the cutting edge 11a into contact with different z positions on the cylindrical surface to acquire the contact coordinate values of the three points.

The positional relationship deriving part 28 performs the following calculations:

$$\begin{matrix} {( {R}_{w} + Δ \hat{x} )}^{2} + {( 0 + Δ \hat{y} )}^{2} = {r}_{{w}^{′}}^{2} & [ EQUATION \text{-} 1 ] \\ {( {R}_{w} + Δ \hat{x} - Δ {x}_{1} )}^{2} + {( - Δ Y + Δ \hat{y} )}^{2} = {r}_{{w}^{′}}^{2} & [ EQUATION \text{-} 2 ] \\ {( {R}_{w} + Δ \hat{x} - Δ {x}_{2} )}^{2} + {( - 2 Δ Y + Δ \hat{y} )}^{2} = {r}_{{w}^{′}}^{2} \\ WHEN [ EQUATION \text{-} 1 ] AND [ EQUATION \text{-} 2 ] ARE SIMULTANEOUSLY SATISFIED , 2 ( {R}_{w} + Δ \hat{x} ) Δ {x}_{1} - Δ {x}_{1}^{2} = Δ {Y}^{2} - 2 Δ Y Δ \hat{y} \\ FROM [ EQUATION \text{-} 2 ] AND [ EQUATION \text{-} 3 ] , 2 ( {R}_{w} + Δ \hat{x} ) ( Δ {x}_{2} - Δ {x}_{1} ) + Δ {x}_{1}^{2} - Δ {x}_{2}^{2} = 3 Δ {Y}^{2} - 2 Δ Y Δ \hat{y} \\ WHEN BOTH EQUATION ARE SIMULTANEOUSLY SATISFIED WITH RESPECT TO Δ \hat{y} \\ Δ \hat{x} = \frac{2 Δ {x}_{1}^{2} - Δ {x}_{2}^{2} - 2 Δ {Y}^{2}}{4 Δ {x}_{1} - 2 {x}_{2}} - {R}_{w} \\ Δ \hat{y} = \frac{Δ Y}{2} - \frac{\frac{2 Δ {x}_{1}^{2} - Δ {x}_{2}^{2} - 2 Δ {Y}^{2}}{4 Δ {x}_{1} - 2 {x}_{2}} Δ {x}_{1}}{Δ Y} + \frac{Δ {x}_{1}^{2}}{2 Δ Y} & [ EQUATION \text{-} 3 ]\end{matrix}$$

As described above, the positional relationship deriving part 28 can derive (Δx\hat{ }, Δy\hat{ }).

The attachment error Δz\hat{ } in the Z-axis direction may be derived by the positional relationship deriving part 28 by using, for example, the reference surface of the attachment spindle 41 as described in the second example. As a result, the attachment error (Δx\hat{ }, Δy\hat{ }, Δz\hat{ }) in the tool center is specified. As described above, in the fifth example, a difference between the pre-machined surface and the target surface machined as designed is used to specify the attachment error (Δx\hat{ }, Δy\hat{ }, Δz\hat{ }) in the tool center, and the movement controller 30 can recalculate a feed path with the attachment error corrected accordingly.

### Sixth Example

In a sixth example, a description will be given of a method for measuring deformation of the cutting edge 11a. As described in the third example, the cutting edge 11a may have irregularities. Therefore, in the following, a method for measuring irregularities on the pre-machined surface to which a shape of the cutting edge is transferred and specifying an error in shape of the tool cutting edge from the irregularities on the machined surface will be described. In the sixth example, when an error in shape due to a shape error factor other than deformation of the cutting edge can be estimated, the shape of the pre-machined surface is measured using one cutting edge point on the assumption that feed motion, made by the feed mechanism 7, in a movement direction not used for the cutting is accurate, and thus the error in shape of the tool cutting edge is specified based on a difference between each estimated position on the pre-machined surface and a corresponding detected position on the pre-machined surface. In the sixth example, the movement controller 30 moves the vibration device 10 relative to the to-be-cut object 6 subjected to cutting work (the cut to-be-cut object 6) using the feed capability of the feed mechanism 7 in a movement direction not used for the cutting work and specifies the attachment error of the tool cutting edge based on the coordinate values of at least two positions where the cutting tool 11 comes into contact with the to-be-cut object 6.

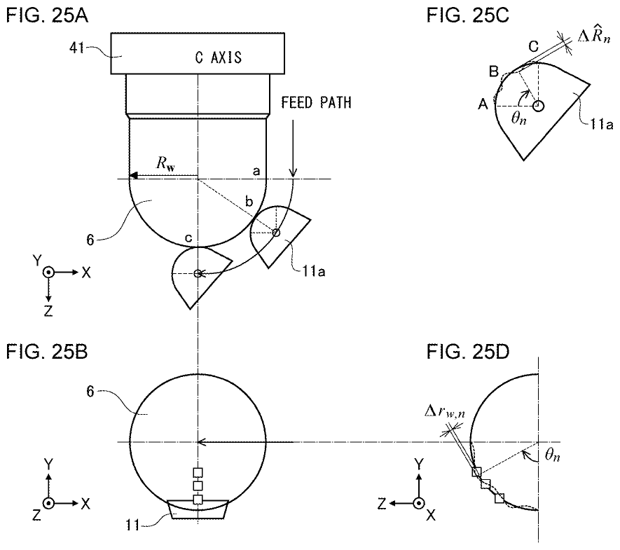

FIG. 25A shows how the hemisphere surface is machined. The movement controller 30 uses the feed capability of the feed mechanism 7 in the X-axis and Z-axis translation directions and the C-axis rotation direction to subject the to-be-cut object 6 to machining work using the cutting tool 11. FIG. 25A shows a state where machining work is performed along an ideal feed path with no attachment error in the tool center. Note that when the attachment error in the tool center is present, it is preferable that the attachment error (Δx\hat{ }, Δy\hat{ }, Δz\hat{ }) be measured before estimating the error in shape of the tool cutting edge, as described in the fifth example. In the following, the positional relationship deriving part 28 estimates the error in shape of the cutting edge from a deviation from an ideal hemispherical shape of the pre-machined surface.

As shown in FIG. 25A, during this spherical machining work, turning work is performed in which the cutting tool 11 is not rotated around the B axis. Referring to FIGS. 25A and 25C, a shape of a point A of the cutting edge 11a is transferred to a shape of a point a of the to-be-cut object 6, a shape of a point B of the cutting edge 11a is transferred to a shape of a point b of the to-be-cut object 6, and a shape of a point C of the cutting edge 11a is transferred to a shape of a point c of the to-be-cut object 6. As described above, the shapes from A to C of the cutting edge 11a are transferred to the pre-machined surface from a to c of the to-be-cut object 6.

At this time, when the shapes from A to C each have an ideal arc shape, a cross section of the spherical surface thus machined has an ideal arc shape accordingly. However, as shown in FIG. 25C, when the cutting edge 11a has irregularities, the irregularities are transferred to the machined surface of the to-be-cut object 6.

FIG. 25B shows how the spherical shape of the to-be-cut object 6 is measured. The movement controller 30 uses the feed capability of the feed mechanism 7 in the Y-axis and Z-axis translation directions to acquire a plurality of contact coordinate values. After aligning the tool center with the C-axis rotation center, the movement controller 30 moves the cutting edge 11a toward the origin of the hemispherical surface while shifting the cutting edge 11a by θn without changing the x position of the cutting edge 11a (x=0). The smaller the shift amount of θn, the larger the number of contact points can be taken. The positional relationship deriving part 28 acquires the coordinates of the plurality of contact points to specify the shape of the arc on the spherical surface with x=0. The positional relationship deriving part 28 can acquire the actual spherical shape of the to-be-cut object 6 to acquire an amount of deviation from the estimated spherical shape, and can thus derive the deformation of the cutting edge 11a. FIG. 25D shows that a detection value of an amount of deviation in spherical surface at θn is Δrw, n, but, at this time, deformation in the radial direction of the cutting edge 11a becomes ΔRn\hat{ } (=−Δrw, n) (see FIG. 25C). As described above, the positional relationship deriving part 28 can measure the shape of the cutting edge.

According to the sixth example, the movement controller 30 can use, with respect to the to-be-cut object 6 subjected to cutting work, the feed capability in the Y-axis translation direction not used for the cutting work to allow the positional relationship deriving part 28 to specify a profile of the shape of the cutting edge based on an amount of deviation from a position where the cutting edge 11a should come into with the to-be-cut object 6 if the cutting edge 11a has the ideal shape. The positional relationship deriving part 28 specifies the profile of the shape of the cutting edge to allow the movement controller 30 to calculate a feed path by taking into account the profile of the shape of the cutting edge. Alternatively, when it is estimated that other machining error factors are small, it is possible to directly correct a tool movement path by the amount of the error in shape measured in the sixth example, and then perform the final finishing work.

### Seventh Example

In the fifth example, the description has been given of the method for, when an attachment error of the cutting tool 11 is present, deriving the attachment error (Δx\hat{ }, Δy\hat{ }, Δz\hat{ }) in the tool center. In the seventh example, a description will be given of a method for, when not only an attachment error of the cutting tool 11 is present but also an error in the feed direction of the tool is present, deriving these errors.

In the seventh example as well, the movement controller 30 moves the vibration device 10 relative to the to-be-cut object 6 subjected to cutting work using the feed capability of the feed mechanism 7 in a movement direction not used for the cutting work and specifies the attachment error of the tool cutting edge based on the coordinate values of at least two positions where the cutting tool 11 comes into contact with the to-be-cut object 6.

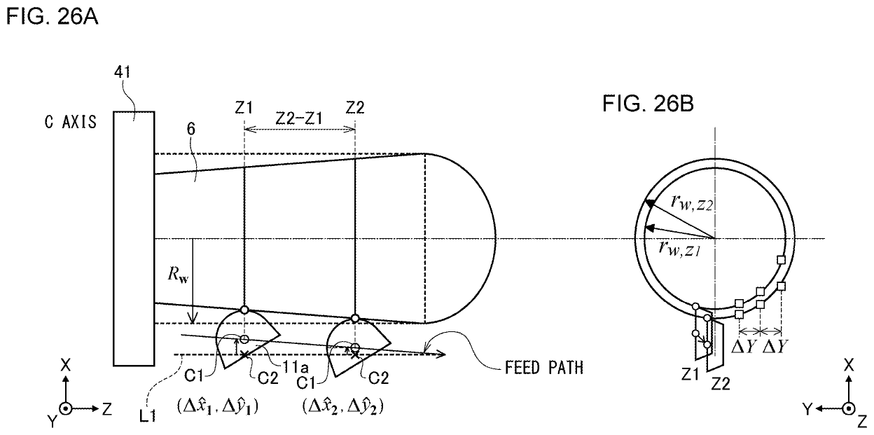

FIG. 26A shows a state when the cutting tool 11 is moved in the Z-axis direction to perform pre-machining work. The movement controller 30 uses the feed capability of the feed mechanism 7 in the Z-axis translation direction and the C-axis rotation direction to subject the to-be-cut object 6 to machining work using the cutting tool 11. In this turning work, when the cutting tool 11 is fed along a line L1 parallel to the Z axis, an attachment error is present in the tool center described in the fifth example, and the Z axis and the C-axis rotation center are not parallel to each other, causing a machining error in a target cylindrical surface. To more specifically describe the line L1, in the NC machine tool, the line L1 extends along the Z axis, and therefore the feed path of the cutting tool 11 is calculated on the assumption that the line L1 is parallel to the C-axis rotation center, but the Z axis and the C-axis rotation center are not actually parallel to each other, so that the movement controller 30 moves the cutting edge 11a along a path represented by the solid arrow as the feed path. This forms a pre-machined surface having a shape different from the target shape.

Note that, this parallelism error factor includes, in addition to an assembly error during the manufacture of the machine tool, deformation due to changes in weight distribution during installation, movement of the feed mechanism, or attachment of the to-be-cut object, deformation due to machining force, thermal deformation due to temperature and machining heat and the like. Among these, when considering deformation due to machining force, it is desirable to set machining conditions such that the machining force is approximately the same during the pre-machining work and the final finishing work.

In an error deriving process, the movement controller 30 uses the feed capability of the feed mechanism 7 in the X-axis, Y-axis, and Z-axis translation directions to acquire a plurality of contact coordinate values. The movement controller 30 derives the contact coordinate values of the cutting edge 11a when the y position is changed at each of z positions Z1 and Z2 and moved in the x direction three times. Deriving the contact coordinate values of the three points causes, as described in the fifth example, an amount of positional deviation (Δx\hat{ }1, Δy\hat{ }), (Δx\hat{ }2, Δy\hat{ }2) from the ideal tool center position to be derived.

The positional relationship deriving part 28 can calculate a locus of the feed path by deriving (Δx\hat{ }1, Δy\hat{ }1, Z1), (Δx\hat{ }2, Δy\hat{ }2, Z2). Here, for any z, when a position error expected to be present relative to the C-axis rotation center is denoted by (Δx\hat{ }, Δy\hat{ }), it results in:

$$\frac{Δ \hat{x} - Δ {\hat{x}}_{1}}{Δ {\hat{x}}_{2} - Δ {\hat{x}}_{1}} = \frac{Δ \hat{y} - Δ {\hat{y}}_{1}}{Δ {\hat{y}}_{2} - Δ {\hat{y}}_{1}} = \frac{z - Z 1}{Z 2 - Z 1} ,$$

and

in turn results in:

$$( Δ \hat{x} , Δ \hat{y} ) = ( Δ {\hat{x}}_{1} + \frac{( Δ {\hat{x}}_{2} - Δ {\hat{x}}_{1} ) ( z - Z 1 )}{Z 2 - Z 1} , Δ {\hat{y}}_{1} + \frac{( Δ {\hat{y}}_{2} - Δ {\hat{y}}_{1} ) ( z - Z 1 )}{Z 2 - Z 1} )$$

Note that the positional deviation between the two Z positions is linearly interpolated, but a positional deviation among three or more Z positions may be measured to make the degree of interpolation higher.

As described above, according to the seventh example, the movement controller 30 can use, with respect to the to-be-cut object 6 subjected to cutting work, the feed capability in the X-axis and Y-axis translation directions not used for the cutting to allow the positional relationship deriving part 28 to estimate a parallelism in the feed direction of the cutting tool 11 along the C axis based on the amount of deviation from a position where the cutting tool 11 should come into with the to-be-cut object 6 if the to-be-cut object 6 has the ideal shape. In the seventh example, the positional relationship deriving part 28 can estimate the parallelism in the feed direction of the cutting tool 11 with respect to the C axis to specify a deviation in movement direction of the cutting tool 11 relative to the to-be-cut object 6. When the position error at any z is determined as represented by the above equation, the movement controller 30 can calculate a feed path with the position error corrected.

### Eighth Example

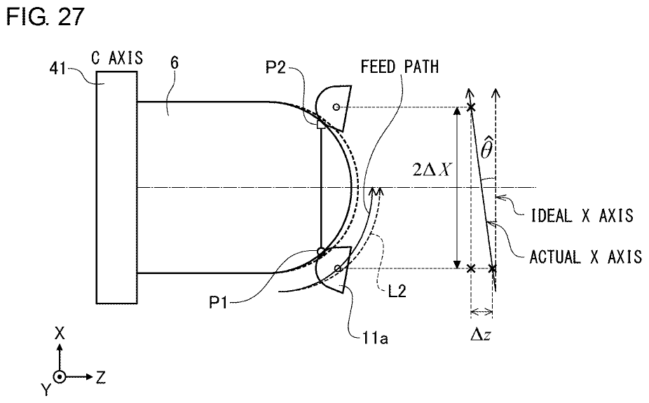

FIG. 27 shows a state where the cutting tool 11 is moved in the X-axis direction and the Z-axis direction to pre-machine a spherical surface. In this turning work, the X axis should be orthogonal to the C axis, but the orthogonality is broken, causing a machining error in the spherical surface. In the NC machine tool, a feed path that is a line L2 for machining the spherical surface is calculated using the X axis as a reference, but the orthogonality between the X axis for tool control and the C axis that is the rotation axis of the to-be-cut object 6 is broken, causing the movement controller 30 to move the cutting edge 11a along a path represented by the solid arrow as the feed path.

In an error deriving process, the movement controller 30 brings the cutting edge 11a into contact with a certain machining point P₁ and a point P₂ that is located symmetrical about the C axis. At this time, from a difference between a movement distance (2ΔX) in the X direction and a Y-direction detection value (Δz), θ\hat{ } denoting the orthogonality between the C axis and the X axis is determined from the following equation:

\hat{θ}=atan(Δz/2ΔX)

As described above, when θ\hat{ } denoting the orthogonality is determined, the movement controller 30 calculates a feed path of the tool in which θ\hat{ } is set to zero and makes a correction.

Note that this method is also applicable to surfaces other than spherical surfaces (including flat surfaces and aspherical surfaces).

In the eighth example as well, the movement controller 30 moves the vibration device 10 relative to the to-be-cut object 6 subjected to cutting work using the feed capability of the feed mechanism 7 in a movement direction not used for the cutting and specifies the attachment error of the tool cutting edge based on the coordinate values of at least two positions where the cutting tool 11 comes into contact with the to-be-cut object 6.

As described above, in the eighth example, the positional relationship deriving part 28 can estimate the orthogonality of the X axis to the C axis to specify the amount of deviation in movement direction of the cutting tool 11 relative to the to-be-cut object 6.

### Ninth Example

In the fifth example, the attachment error (Δx\hat{ }, Δy\hat{ }, Δz\hat{ }) in the tool center is estimated using the coordinate value when the cutting edge 11a is brought into contact with the cylindrical surface. In a ninth example, the attachment error (Δx\hat{ }, Δy\hat{ }, Δz\hat{ }) in the tool center is estimated using a coordinate value when the cutting edge 11a is brought into contact with a pre-machined spherical surface. For example, the pre-machined spherical surface may be a surface resulting from removing the cylindrical surface from the to-be-cut object 6 shown in FIGS. 23A-23C. The movement controller 30 uses the feed capability of the feed mechanism 7 in the X-axis and Z-axis translation directions and the C-axis rotation direction to subject the to-be-cut object 6 to pre-machining work using the cutting tool 11.

In the method shown in the ninth example, movement control is performed to bring the cutting edge 11a into contact with three points on the same Z position. In an error deriving process, the movement controller 30 uses the feed capability of the feed mechanism 7 in the X-axis, Y-axis, and Z-axis translation directions to acquire a plurality of contact coordinate values.

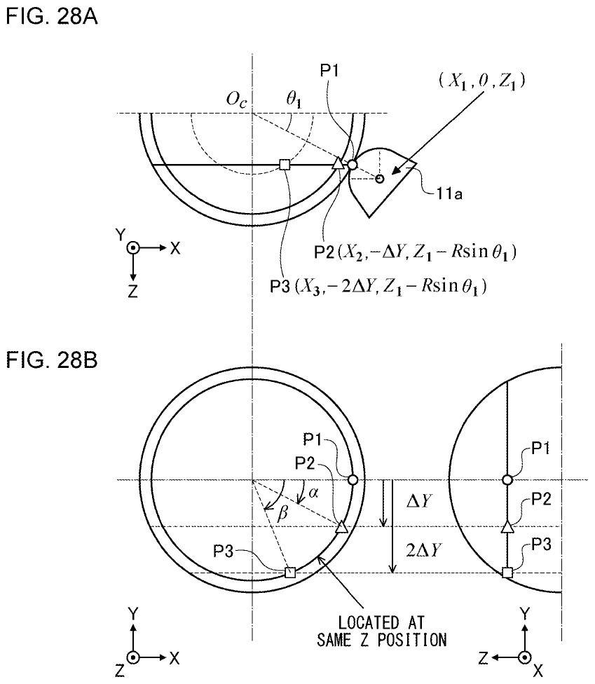

FIG. 28A shows a state where P1 is machined by the cutting edge 11a. The tool center coordinates on the NC machine tool are known and are (X1, 0, Z1). An angle of a line segment connecting a workpiece center Oc and P1 with respect to the XY plane is θ1. When the nose radius of the cutting edge 11a is denoted by R, the coordinates of P1 serving as a machining point becomes

P1: (X1−R cos θ1,0,Z1−R sin θ1).

Once the coordinates of P1 are determined, P2, P3 to be touched are defined on the same Z position (Z1−R sin θ1) as P1 (see FIG. 28B) and at positions (see FIG. 28C) shifted by ΔY, 2ΔY from P1 in the Y-axis negative direction. Further, in the XY plane, an angle between a line segment connecting the C-axis rotation center and P1 and a line segment connecting the C-axis rotation center and P2 is denoted by a, and an angle between a line segment connecting the C-axis rotation center and P1 and a line segment connecting the C-axis rotation center and P3 is denoted by β (see FIG. 28B).

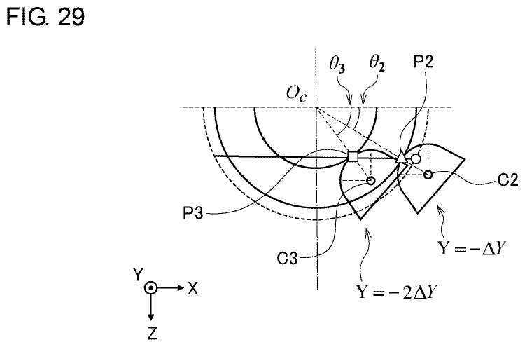

FIG. 29 shows an angle of a line segment connecting the workpiece center Oc and a contact point in the XY plane. Herein, an angle of a line segment extending to P2 is denoted by θ2, and an angle of a line segment extending to P3 is denoted by θ3.

Therefore, the tool center coordinates (C2) for making contact with P2 and the tool center coordinates (C3) for making contact with P3 are calculated as follows.

C2: (X2+R cos θ2,−ΔY,Z1−R sin θ1+R sin θ2)

C3: (X3+R cos θ3,−2ΔY,Z1−R sin θ1+R sin θ3)

The positional relationship deriving part 28 calculates X2, X3, α, β, θ1, θ2, and θ3 from the following geometric relational expressions:

$$* GEOMETRIC RELATIONAL {EXPRESSION \\ ( {X}_{1} - R cos {θ}_{1} )}^{2} = {X}_{2}^{2} + {( - Δ Y )}^{2} = {X}_{3}^{2} + {( - 2 Δ Y )}^{2} = ( RADIUS OF { CIRCLE PASSING THROUGH THREE CONTACT POINTS )}^{2} \\ α = a tan ( \frac{Δ Y}{{X}_{2}} ) \\ Β = a tan ( \frac{2 Δ Y}{{X}_{3}} ) \\ {θ}_{1} = a tan ( \frac{{Z}_{1}}{{X}_{1}} ) \\ {θ}_{2} = a tan ( \frac{{Z}_{1} - R sin {θ}_{1}}{{X}_{2}} ) \\ {θ}_{3} = a tan ( \frac{{Z}_{1} - R sin {θ}_{1}}{{X}_{3}} )$$

The origin of each coordinate value is Oc, Oc is a point that is located on the C-axis rotation center line and is identical in z coordinate value to a center (when a tool installation error is present, displaced from the C-axis rotation center line accordingly) of a locus of a machined point (arc in a plane parallel to the XZ plane).

The movement controller 30 brings the cutting edge 11a into contact with P2 and P3. At this time, the movement controller 30 adjusts (y, z) of the center coordinates of the cutting edge 11a to the coordinate values of C2 and C3, and then moves the cutting edge 11a in the X direction to bring the cutting edge 11a into contact with the spherical surface. At this time, when contact is made with the same x coordinate value as the calculated value, it is determined that no attachment error is present in the center coordinate. On the other hand, when contact is made at the x position of the tool center on the NC machine tool different from the calculated value, the amount of movement in the X direction is detected as an error.

Detection C2: (X2+Δx2+R cos θ2,−ΔY,Z1−R sin θ1+R sin θ2)

Detection C3: (X3+Δx3+R cos θ3,−2ΔY,Z1−R sin θ1+R sin θ3)

Δx2 and Δx3 are detection values.

From the detection values, P2 and P3 can be approximately derived as follows:

Detection P2: (X2+Δx2,−ΔY,Z1−R sin θ1)

Detection P3: (X3+Δx3,−2ΔY,Z1−R sin θ1)

Note that, regarding the error in the z position, the nose radius of the tool is generally smaller than the radius of the machined surface, and even when the attachment error is present, a locus shape of the machined point (in a plane parallel to the XZ plane) has a correct curvature viewed in the Y direction (an error is present in the curvature when the XY cross section is viewed in the Z direction) because the locus shape is merely translated by the amount of attachment error; and therefore, a deviation in the z position is smaller than a deviation in the x position. Therefore, the deviation in the z position can be ignored.

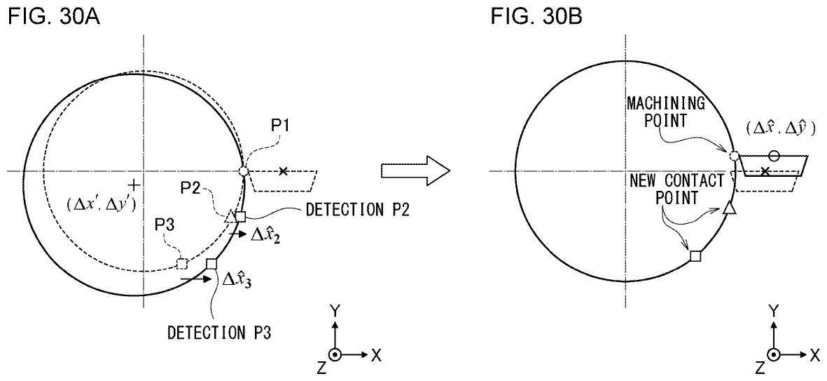

FIG. 30A shows a relationship between an initial circle formed by P1, P2, and P3 and a virtual circle formed by using errors (Δx2, Δx3) derived from the initial circle. The virtual circle passes through P1, detection P2, and detection P3. (Δx′, Δy′) is the center of the virtual circle.

FIG. 30B shows a coordinate system in which the center coordinates of the virtual circle are returned to the origin. At this time, the tool attachment error (Δx\hat{ }, Δy\hat{ }) is estimated by the following equation:

(Δx\hat{ },Δy\hat{ })=(−Δx′,−Δy′).

The positional relationship deriving part 28 uses the estimated tool attachment error (Δx\hat{ }, Δy\hat{ }) to calculate X2, X3, α, β, θ1 (the first contact point remains the same as during machining work and does not change from the first contact, and therefore, similar to X1 and Z1, θ1 does not change and need not necessarily be recalculated), 02, and 03 again from the following geometric relational expressions:

$$* GEOMETRIC RELATIONAL {EXPRESSION \\ ( {X}_{1} - Δ \hat{x} - R cos {θ}_{1} )}^{2} + {( Δ \hat{y} )}^{2} = {X}_{2}^{2} + {( Δ \hat{y} - Δ Y )}^{2} = {X}_{3}^{2} + {( Δ \hat{y} - 2 Δ Y )}^{2} = ( RADIUS {OF CIRCLE PASSING THROUGH THREE CONTACT POINTS )}^{2} \\ α = a tan ( \frac{Δ \hat{y}}{{X}_{1} + Δ \hat{x} - R cos {θ}_{1}} ) - a tan ( \frac{Δ \hat{y} - Δ Y}{{X}_{2}} ) \\ β = a tan ( \frac{Δ \hat{y}}{{X}_{1} + Δ \hat{x} - R cos {θ}_{1}} ) - a tan ( \frac{Δ \hat{y} - 2 Δ Y}{{X}_{3}} ) \\ {θ}_{1} = a tan ( \frac{{Z}_{1}}{{X}_{1}} ) \\ {θ}_{2} = a tan ( \frac{{Z}_{1} - R sin {θ}_{1}}{{X}_{2} - ( Δ \hat{x} cos α + Δ \hat{y} sin α )} ) \\ {θ}_{3} = a tan ( \frac{{Z}_{1} - R sin {θ}_{1}}{{X}_{3} - ( Δ \hat{x} cos β + Δ \hat{y} sin β )} )$$

derived to bring the cutting edge 11a into contact with new P2 and P3. The movement controller 30 adjusts (y, z) of the center coordinates of the cutting edge 11a to the coordinate values of C2 and C3, and then moves the cutting edge 11a in the X direction to bring the cutting edge 11a into contact with the spherical surface. At this time, when contact is made with the same center coordinates as the calculated values, it is determined that no estimated error is present in the estimated value of attachment error of the center coordinates. Repeating this process allows the cutting edge 11a to come into contact with the spherical surface of the to-be-cut object 6 with the center coordinates that can be regarded as being the same as the calculated values, that is, the estimation error is sufficiently small, and the accurate attachment error is determined.

In the ninth example as well, the movement controller 30 moves the vibration device 10 relative to the to-be-cut object 6 subjected to cutting work using the feed capability of the feed mechanism 7 in a movement direction not used for the cutting and specifies the attachment error of the tool cutting edge based on the coordinate values of at least two positions where the cutting tool 11 comes into contact with the to-be-cut object 6.

As described above, in the ninth example, the difference between the pre-machined spherical surface and the target surface machined as designed is reduced by repeated calculation, and the attachment error (Δx\hat{ }, Δy\hat{ }, Δz\hat{ }) in the tool center is specified accordingly.

### Tenth Example

In the fifth to ninth examples, the turning work during which the cutting tool 11 is not rotated about the B axis has been described, but in a tenth example, a description will be given of machining work during the cutting tool 11 is rotated about the B axis, and only one point of the cutting edge 11a is used.

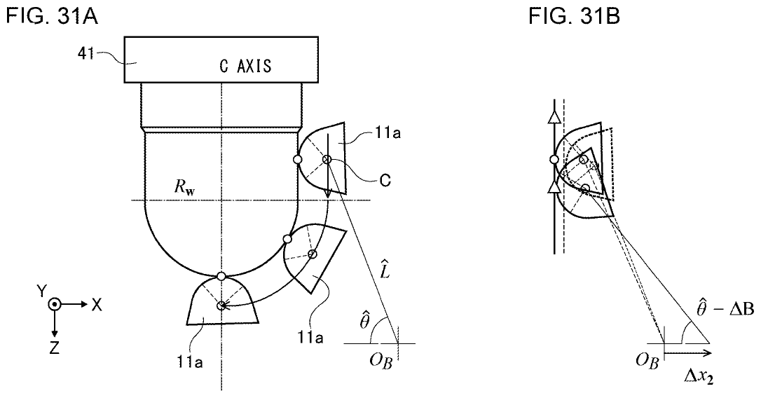

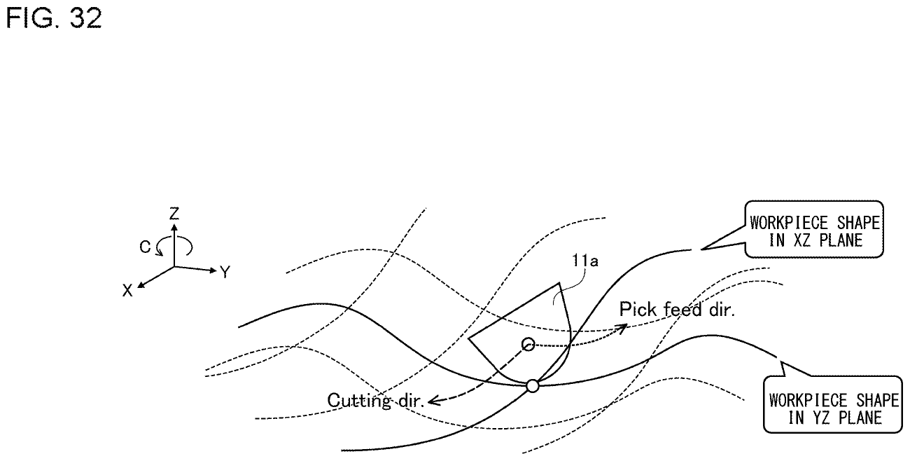

FIG. 31A shows a state where one point of the cutting edge 11a is used for cutting during machining work. In such machining work, when an error is present in attachment position of the tool center C relative to a B-axis center O_{B}, a machining error occurs.

FIG. 31B is a diagram for describing determination of a distance L\hat{ } between the B-axis center O_{B} and the tool center C and an initial attachment angle θ\hat{ }. As shown in FIGS. 31A and 31B, the movement controller 30 changes the attachment angle by +ΔB and −ΔB with a predetermined y coordinate and z coordinate, detects increments Δx₁ and Δx₂ in the x coordinate at the contact point of the cutting edge 11a, and performs calculations using the increments as follows:

$$\begin{matrix}\hat{L} cos ( \hat{θ} + Δ B ) = \hat{L} cos \hat{θ} + Δ {x}_{1} & [ EQUATION \text{-} 1 ] \\ \hat{L} cos ( \hat{θ} + Δ B ) = \hat{L} cos \hat{θ} + Δ {x}_{2} \\ WHEN [ EQUATION \text{-} 1 ] AND [ EQUATION \text{-} 2 ] ARE REARRANGED FOR \hat{L} WITH RESPECT TO \hat{θ} \\ \hat{L} ( cos ( \hat{θ} + Δ B ) - cos ( \hat{θ} - Δ B ) ) = Δ {x}_{1} - Δ {x}_{2} \\ \hat{L} = \frac{Δ {x}_{2} - Δ {x}_{1}}{2 sin Δ B \times sin \hat{θ}} \\ WHEN \hat{L} IS SUBSTITUTED INTO [ EQUATION \text{-} 1 ] \\ \hat{θ} = a tan ( \frac{( 1 - cos Δ B ) ( Δ {x}_{1} - Δ {x}_{2} )}{sin Δ B ( Δ {x}_{1} + Δ {x}_{2} )} ) & [ EQUATION \text{-} 2 ]\end{matrix}$$

As described above, the distance L\hat{ } and the angle θ\hat{ } that correspond to the attachment position of the tool center C relative to the B-axis rotation center are determined.

### Eleventh Example

In an eleventh example, an error in the C-axis rotation center is first identified using a surface pre-machined by scanning-line machining work. In the eleventh example as well, the error in relative C-axis rotation center position viewed from the tool center is identified by bringing the cutting edge 11a into contact with the pre-machined surface at a plurality of points and deriving a difference from an ideal profile.

FIG. 32 conceptually shows a cutting feed direction in the XZ plane and a pick feed direction in the YZ plane during the scanning-line machining work. In order to identify the error in the C-axis rotation center, a workpiece shape in the YZ plane and a workpiece shape in the XZ plane can be used.

### Use of Workpiece Shape in YZ Plane

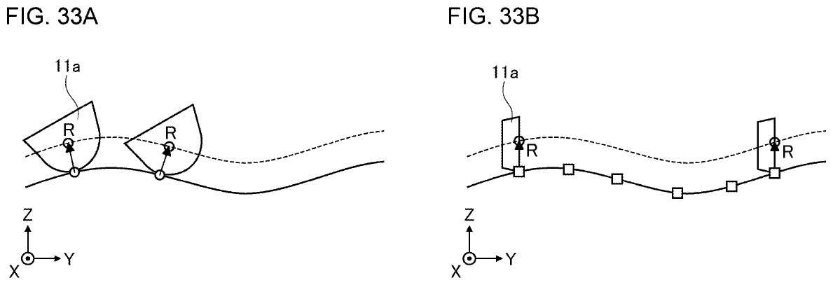

FIG. 33A shows the cutting edge 11a during machining work. In FIG. 33A, the dotted line represents a pick feed profile of the tool center during machining work, and the solid line represents a pre-machined surface profile. An ideal pick feed profile of the tool center and pre-machined surface profile are known.

FIG. 33B shows a state where the C-axis (here, the C-axis is applied to the tool side) is rotated 90 degrees from a position during machining work, and then the cutting edge 11a is brought into contact with the pre-machined surface at a plurality of points. In FIG. 33B, the solid line represents a contact surface profile connecting the contact points.

The positional relationship deriving part 28 identifies a Y-direction error in the C-axis rotation center (X-direction error after and before the C-axis rotation) by numerical analysis such that the contact surface profile and the pre-machined surface profile fit each other best. Specifically, the positional relationship deriving part 28 estimates each contact position from the pre-machined surface profile, derives differences from detected positions where actual contact is made, and identifies the C-axis rotation center coordinates such that the sum of the differences is as small as possible.

### Use of Workpiece Shape in XZ Plane

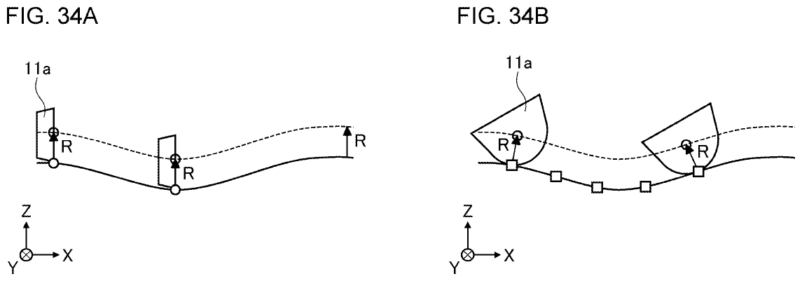

FIG. 34A shows the cutting edge 11a during machining work. In FIG. 34A, the dotted line represents a cutting motion profile of the tool center during machining work, and the solid line represents a pre-machined surface profile. An ideal cutting motion profile of the tool center and pre-machined surface profile are known.

FIG. 34B shows a state where the C axis is rotated 90 degrees from a position for machining work, and then the cutting edge 11a is brought into contact with the pre-machined surface at a plurality of points. In FIG. 34B, the solid line represents a contact surface profile connecting the contact points.

The positional relationship deriving part 28 identifies an X-direction error in the C-axis rotation center (Y-direction error after and before the C-axis rotation) by numerical analysis such that the contact surface profile and the pre-machined surface profile fit each other best. Specifically, the positional relationship deriving part 28 estimates each contact position from the pre-machined surface profile, derives differences from detected positions where actual contact is made, and identifies the C-axis rotation center coordinates such that the sum of the differences is as small as possible.

As shown in FIG. 33B or FIG. 34B, the relative C-axis rotation center position viewed from the tool center is identified. The identification of the C-axis rotation center position allows an error in shape of the cutting edge 11a to be measured.

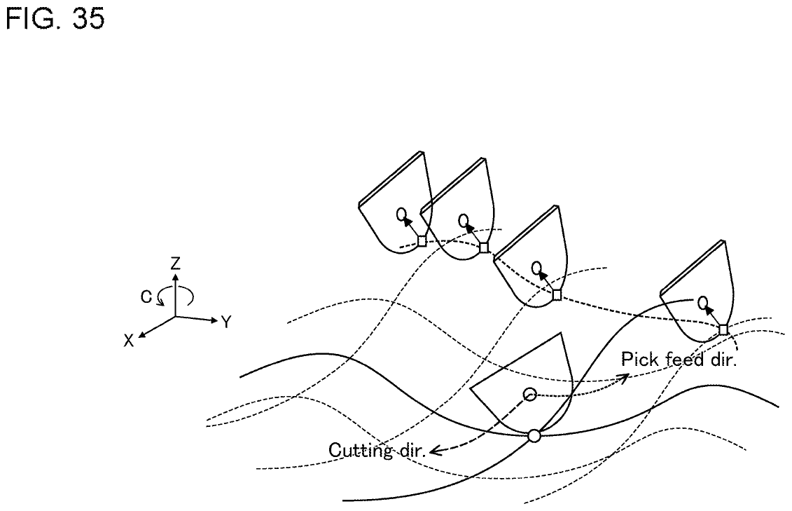

FIG. 35 shows a technique for measuring an error in shape of the cutting edge. The movement controller 30 rotates the C axis 90 degrees from a position for machining work and brings the cutting edge 11a into contact with the pre-machined surface at a plurality of points along a curve such that the same cutting edge position is brought into contact with the pre-machined surface. FIG. 35 shows a state where the lowest point of the cutting edge in the Z direction comes into contact with the pre-machined surface along a ridge represented by the broken line. The positional relationship deriving part 28 measures deformation in shape of the cutting edge as in the sixth example based on an amount of deviation between the calculated contact position and the detected contact position at each contact point.

### Twelfth Example

In a twelfth example, an error in the C-axis rotation center is identified using a surface pre-machined by contour-line machining work. In this case, the positional relationship deriving part 28 does not change the positions of the C axis and the Z axis as described in the ninth example, but can use the coordinate values of two or more points where the cutting edge 11a comes into contact by changing the XY position to identify an xy relative position between the C-axis rotation center and the cutting edge 11a.

Further, making contact at multiple points on a curve where the same cutting edge position comes into contact in a position 90 degrees different in C-axis rotation position from a position during pre-machining work makes it possible to measure an error in shape of the tool cutting edge. Further, as described in the seventh example, changing the Z position and making contact at two or more points in a position 90 degrees different in C-axis rotation position from a position during pre-machining work makes it possible to identify the parallelism (inclination) between the C-axis rotation center and the Z axis.

### Thirteenth Example

In a thirteenth example, a description will be given of a method for identifying a tool attachment angle and a B-axis rotation center position using a machined surface to which a straight cutting edge is transferred.

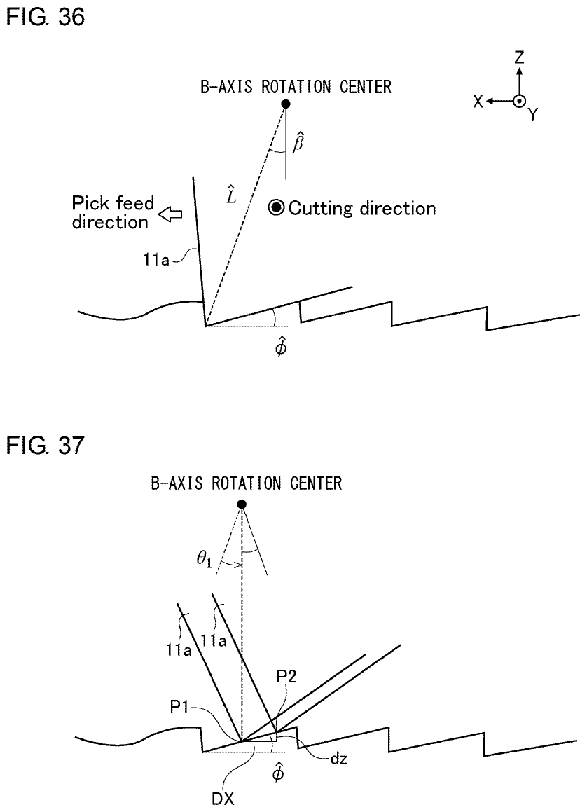

FIG. 36 shows a state where machining work is performed with the cutting edge 11a that is a straight cutting edge. A description will be given below of a method for identifying an inclination φ\hat{ } of a main inclined surface of a fine groove of an already machined surface determined by the attachment angle of the tool, L\hat{ } that is a distance between the B-axis rotation center and the tip of the cutting edge, and β\hat{ } that is an inclination with respect to the Z axis. The inclination φ\hat{ } is an angle with the counterclockwise direction from the −X axis serving as a positive direction, and the inclination R\hat{ } is an angle from the −Z axis.

FIG. 37 is a diagram for describing the identification method. The movement controller 30 brings the cutting edge 11a into contact with the pre-machined surface at P1 at any angle θ1 to detect z1 that is the z position of P1. With the position kept unchanged, the movement controller 30 brings the cutting edge 11a into contact with the pre-machined surface at P2 shifted by DX to detect z2 that is the z position of P2.

Thus, when dz=z2−z1,

φ\hat{ }=atan(dz/|DX|) is calculated. When this inclination angle is different from an inclination angle of the target shape, correcting the difference with the B axis allows machining work by which fine grooves having more accurate inclined surfaces are formed to be performed in the final finishing work.

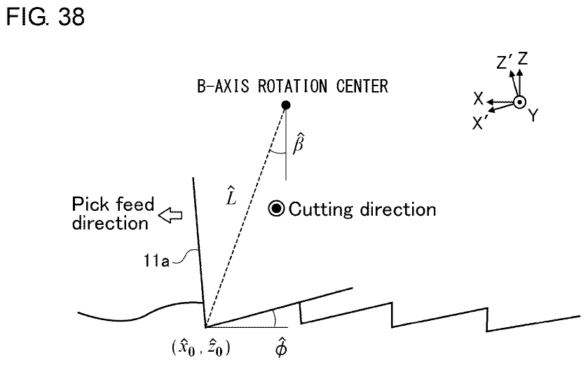

FIG. 38 is a diagram for describing a coordinate conversion.

A relative relationship between the cutting edge tip point and the B-axis rotation center is represented as follows:

$$\{ \} = \{ \begin{matrix}- \hat{L} sin \hat{β} \\ - \hat{L} cos \hat{β}\end{matrix} \}$$

When the coordinate system is converted using p to make the z coordinate at the cutting position equal to zero, it results in

$$\{ \} = [ \begin{matrix}cos φ & sin φ \\ - sin φ & cos φ\end{matrix} ] \{ \begin{matrix} \\ \end{matrix} \} \qquad$$

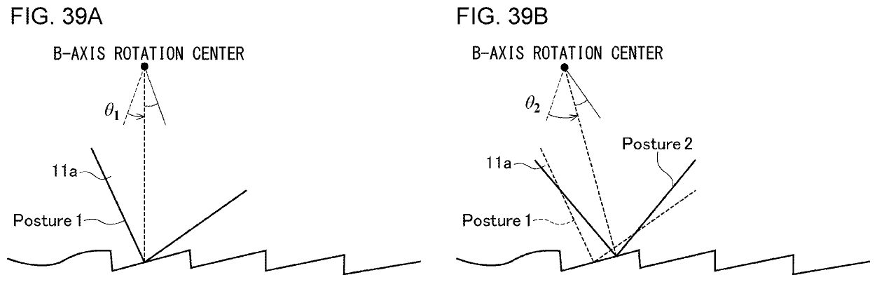

FIGS. 39A and 39B show states where the position of the cutting edge 11a is changed and brought into contact with the pre-machined surface.

FIG. 39A shows a state where, with the B axis rotated by θ1, the cutting edge 11a is moved in a direction orthogonal to the inclination p (parallel to the Z′ axis) to come into contact with the pre-machined surface. FIG. 39B shows a state where, with the B axis rotated by θ2, the cutting edge 11a is moved in the direction orthogonal to the inclination φ (parallel to the Z′ axis) to come into contact with the pre-machined surface. For θ1 and θ2, the counterclockwise direction is a positive direction. At this time, z′1 and z′2 are detected as z values.

Therefore, the following relationships are satisfied:

$$\{ \} = [ \begin{matrix}cos {θ}_{1} & - sin {θ}_{1} \\ sin {θ}_{1} & cos {θ}_{2}\end{matrix} ] \{ \} + \{ \begin{matrix}0 \\ {x}_{1 +}^{′}\end{matrix} \}$$

$$\{ \begin{matrix} \\ \end{matrix} \} = [ \begin{matrix}cos {θ}_{2} & - sin {θ}_{2} \\ sin {θ}_{2} & cos {θ}_{2}\end{matrix} ] \{ \} + \{ \begin{matrix}0 \\ {x}_{2 +}^{′}\end{matrix} \}$$

where x′1+ and x′2+ denote any shift amounts, and a shift need not be made.

The z′ coordinates at the two contact points described above are determined as follows:

dz₁′=zₗ′−z₀′= [symbol] sin θₗ+(cos θₗ−1) [symbol] \textcircled{1}

dz₂′=z₂′−z₀′= [symbol] sin θ₂+(cos θ₂−1) [symbol] \textcircled{2}

When the equations are solved simultaneously, it results in:

$$= \frac{ ( cos {θ}_{1} - 1 ) - {dz}_{1}^{′}}{sin {θ}_{1}} … \qquad$$

Therefore,

$$\begin{matrix}{dz}_{2}^{′} = - sin {θ}_{2} \frac{ ( cos {θ}_{1} - 1 ) - {dz}_{1}^{′}}{sin {θ}_{1}} + ( cos {θ}_{2} - 1 ) \\ = \frac{sin {θ}_{2}}{sin {θ}_{1}} {dz}_{1}^{′} + ( ( cos {θ}_{2} - 1 ) - \frac{sin {θ}_{2} ( cos {θ}_{1} - 1 )}{sin {θ}_{1}} ) \end{matrix}$$

$$= \frac{{dz}_{2}^{′} - \frac{sin {θ}_{2}}{sin {θ}_{1}} {dz}_{1}^{′}}{( cos {θ}_{2} - 1 ) - \frac{sin {θ}_{2} ( cos {θ}_{1} - 1 )}{sin {θ}_{1}}} … , \\ IS SUBSTITUTED INTO \text{:} = \frac{( cos {θ}_{1} - 1 )}{sin {θ}_{1}} {z}_{0}^{′} - \frac{{dz}_{1}^{′}}{sin {θ}_{1}}$$

Therefore,

$$\{ \} = [ \begin{matrix}cos φ & - sin φ \\ sin φ & cos φ\end{matrix} ] \{ \begin{matrix} \\ \end{matrix} \}$$

$$FROM = - \hat{L} sin \hat{β} , = - \hat{L} cos \hat{β} , \\ \hat{β} = a tan ( \frac{}{} )$$

$$\hat{L} = \frac{-}{sin β}$$

is calculated.

As described above, according to the thirteenth example, bringing the cutting edge 11a into contact with a plurality of points on the machined surface to which the straight cutting edge has been transferred makes it possible to derive the B-axis rotation center. When it is necessary to perform machining work while rotating the B axis because, in a complicated shape such as fine grooves formed on a free-curved surface, an angle of inclined surfaces of the fine grooves varies, grasping the accurate B-axis rotation center as described above makes it possible to prevent a reduction in machining accuracy due to a deviation in the xy position of the tool cutting edge (when an error is present in the B-axis rotation center position relative to the tool cutting edge position, an error in xy position of the tool cutting edge is caused by the B-axis rotation).

The present disclosure has been described based on the examples. It is to be understood by those skilled in the art that the examples are illustrative and that various modifications are possible for a combination of components or processes, and that such modifications are also within the scope of the present disclosure.

An outline of aspects of the present disclosure is as follows. A vibration cutting apparatus according to one aspect of the present disclosure includes a vibration device having a cutting tool attached thereto, the vibration device including an actuator structured to generate vibration, a movement controller structured to control a feed mechanism to move the vibration device relative to a target object (such as a workpiece, a component to which the workpiece is attached, or an object having a known shape), and a vibration controller structured to control the vibration of the actuator of the vibration device. The vibration controller has a capability of acquiring a status value indicating a vibration control status and detects contact between the cutting tool and the target object based on a change in the status value. According to this aspect, the vibration controller detects the contact between the cutting tool and the workpiece based on a change in vibration control status value, thereby eliminating the need for installing, for example, a separate sensor that detects the contact.

The vibration controller may acquire at least one of energy consumption required for the vibration and a resonance frequency as the status value. The vibration controller may acquire power consumption required for bending vibration as the status value. Further, it is preferable that the vibration controller specifies the contact position.

The vibration cutting apparatus according to another aspect of the present disclosure includes a vibration device having a cutting tool attached thereto, the vibration device including an actuator structured to generate vibration, and a controller structured to control a feed mechanism to move the vibration device relative to a workpiece or a component. The controller has a capability of acquiring a coordinate value when the cutting tool comes into contact with the workpiece or the component by controlling the feed mechanism to relatively move the vibration device. The controller determines a relative positional relationship between the cutting tool and a rotation center of the workpiece based on coordinate values when the cutting tool comes into contact with the workpiece subjected to turning work or a reference surface whose relative positional relationship with the rotation center of the workpiece is known at least at two positions different from a rotation angle position of the cutting tool during the turning work. The controller determines the relative positional relationship between the cutting tool and the rotation center of the workpiece based on the coordinate values of the two or more contact positions, thereby eliminating the need for installing, for example, a separate measuring instrument that measures the positional relationship.

The vibration cutting apparatus according to yet another aspect of the present disclosure includes a vibration device having a cutting tool attached thereto, the vibration device including an actuator structured to generate vibration, and a controller structured to control a feed mechanism to move the vibration device relative to a workpiece or a component. The controller has a capability of acquiring a coordinate value when the cutting tool comes into contact with the workpiece or the component by controlling the feed mechanism to relatively move the vibration device. The controller determines a relative positional relationship between the cutting tool and at least one among an attachment surface of the workpiece, a feed motion direction of the workpiece, and a rotation center of the workpiece based on a coordinate value of a contact position on a reference surface whose relative positional relationship with at least one among the attachment surface of the workpiece, the feed motion direction of the workpiece, and the rotation center of the workpiece is known. Note that a linear feed motion of the workpiece and a rotary motion of the workpiece around the linear feed motion are made in three directions in the space, but in the vibration cutting apparatus, the workpiece is moved relative to the cutting tool; therefore, the position of the workpiece may be fixed, and the cutting tool may move. Using the reference surface whose relative positional relationship is known to bring the tool cutting edge into contact with the reference surface allows the relative positional relationship to be determined.

The vibration cutting apparatus according to yet another aspect of the present disclosure includes a vibration device having a cutting tool attached thereto, the vibration device including an actuator structured to generate vibration, and a controller structured to control a feed mechanism to move the vibration device relative to a target object. The controller has a capability of acquiring a coordinate value when a cutting edge of the cutting tool comes into contact with a portion having a known shape of an object by controlling the feed mechanism to move the vibration device relative to the portion having the known shape of the object. The controller specifies information on the cutting edge of the cutting tool based on coordinate values when the cutting edge of the cutting tool comes into contact with the portion having the known shape of the object at least at three positions. The controller can specify information on the attachment position of the cutting tool by using the coordinate values of three or more contact positions with the portion having the known shape of the object. The controller may obtain at least one among a nose radius of the cutting edge of the cutting tool, center coordinates of the cutting edge of the cutting tool, and an error in shape of the cutting edge of the cutting tool as the information on the attachment position.

The vibration cutting apparatus according to yet another aspect of the present disclosure includes a vibration device having a cutting tool attached thereto, the vibration device including an actuator structured to generate vibration, and a controller structured to control a feed mechanism to move the vibration device relative to a workpiece. The controller has a capability of acquiring a coordinate value when the cutting tool comes into contact with the workpiece by controlling the feed mechanism to relatively move the vibration device. The controller may specify, based on coordinate values when the vibration device is moved relative to the workpiece subjected to cutting work using a feed capability of the feed mechanism in a movement direction not used for the turning to bring the cutting tool into contact with the workpiece at least at two positions, at least one among an attachment error of the cutting tool, an error in shape of the cutting edge of the cutting tool, and a deviation in movement direction of the cutting tool relative to the workpiece. The controller can specify at least one among an attachment error of the cutting tool, an error in shape of the cutting edge of the cutting tool, and a deviation in movement direction of the cutting tool relative to the workpiece by specifying a difference between a shape of the workpiece subjected to cutting work and a shape of the workpiece subjected to ideal cutting work.

The controller controls the vibration of the actuator of the vibration device. The controller may acquire the status value indicating the vibration control status and detects contact between the cutting tool and the workpiece or the reference surface based on a change in the status value.

### DESCRIPTION OF THE REFERENCE NUMERALS

1 vibration cutting apparatus, 6 to-be-cut object, 7 feed mechanism, 10 vibration device, 11 cutting tool, 121, 12b piezoelectric element, 20 controller, 21 vibration controller, 22 drive controller, 231, 23b amplifier, 24 phase shifter, 25 voltage oscillator, 26 phase detector, 27 monitor, 28 positional relationship deriving part, 30 movement controller

### INDUSTRIAL APPLICABILITY

The present disclosure is applicable to a vibration cutting apparatus that cuts a to-be-cut object (workpiece) while vibrating a tool.

1. A vibration cutting apparatus comprising:
a vibration device having a cutting tool attached thereto, the vibration device including an actuator structured to generate vibration;
a movement controller structured to control a feed mechanism to move the vibration device relative to a target object; and
a vibration controller structured to control the vibration of the actuator of the vibration device, wherein
the vibration controller acquires power consumption required for the vibration and detects contact between the cutting tool and the target object based on a change in the power consumption.

2. The vibration cutting apparatus according to claim 1, wherein
the vibration controller specifies a contact position.

3. A vibration cutting apparatus comprising:
a vibration device having a cutting tool attached thereto, the vibration device including an actuator structured to generate vibration; and
a controller structured to control a feed mechanism to move the vibration device relative to a workpiece or a component, wherein
the controller has a capability of acquiring a coordinate value when the cutting tool comes into contact with the workpiece or the component by controlling the feed mechanism to relatively move the vibration device, and
the controller determines a relative positional relationship between the cutting tool and a rotation center of the workpiece based on coordinate values when the cutting tool comes into contact with the turned workpiece or with a reference surface whose relative positional relationship with the rotation center of the workpiece is known at least at two positions different from a rotation angle position of the cutting tool when the workpiece is turned.

4. A vibration cutting apparatus comprising:
a vibration device having a cutting tool attached thereto, the vibration device including an actuator structured to generate vibration; and
a controller structured to control a feed mechanism to move the vibration device relative to a target object, wherein
the controller has a capability of acquiring a coordinate value when a cutting edge of the cutting tool comes into contact with a portion having a known shape of an object by controlling the feed mechanism to move the vibration device relative to the object having the known shape, and
the controller specifies at least one among a nose radius of the cutting edge of the cutting tool, center coordinates of the cutting edge of the cutting tool, and an error in shape of the cutting edge of the cutting tool based on coordinate values when the cutting edge of the cutting tool comes into contact with the portion having the known shape of the object at least at three positions.

5. A vibration cutting apparatus comprising:
a vibration device having a cutting tool attached thereto, the vibration device including an actuator structured to generate vibration; and
a controller structured to control a feed mechanism to move the vibration device relative to a workpiece, wherein
the controller has a capability of acquiring a coordinate value when the cutting tool comes into contact with the workpiece by controlling the feed mechanism to relatively move the vibration device, and
the controller specifies, based on coordinate values when the vibration device is moved relative to the turned workpiece by a feed capability of the feed mechanism in a movement direction not used for the turning to bring the cutting tool into contact with the workpiece at least at two positions, at least one among an attachment error of the cutting tool, an error in shape of a cutting edge of the cutting tool, and a deviation in movement direction of the cutting tool relative to the workpiece.

6. The vibration cutting apparatus according to claim 3, wherein
the controller controls the vibration of the actuator of the vibration device, and
the controller acquires a status value indicating a vibration control status and detects contact between the cutting tool and a workpiece or a reference surface based on a change in the status value.

7. A non-transitory computer-readable recording medium storing a computer program causing a computer to execute:
controlling a feed mechanism to move a vibration device relative to a target object, the vibration device having a cutting tool attached thereto, the vibration device including an actuator structured to generate vibration; and
controlling the vibration of the actuator of the vibration device, wherein
the controlling of the vibration includes acquiring power consumption required for the vibration, and detecting contact between the cutting tool and the target object based on a change in the power consumption.

8. The vibration cutting apparatus according to claim 4, wherein the controller controls the vibration of the actuator of the vibration device, and
the controller acquires a status value indicating a vibration control status and detects contact between the cutting tool and a workpiece or a reference surface based on a change in the status value.

9. The vibration cutting apparatus according to claim 5, wherein the controller controls the vibration of the actuator of the vibration device, and
the controller acquires a status value indicating a vibration control status and detects contact between the cutting tool and a workpiece or a reference surface based on a change in the status value.
